(19) United States
(12) Patent Application Publication
(10) Pub. No.: US 2016/0047888 A1
(43) Pub. Date: Feb. 18, 2016

(54) VEHICLE POSITIONING

(71) Applicant: Richard D. Roberts, Hillsboro, OR (US)

(72) Inventor: Richard D. Roberts, Hillsboro, OR (US)

(21) Appl. No.: 14/461,169

(22) Filed: Aug. 15, 2014

(51) Int. Cl. G01S 5/16; G01S 17/32

(52) U.S. Cl. CPC G01S 5/16; G01S 17/32

(57) ABSTRACT

Aspects of the disclosure include vehicle positioning. In at least certain aspects, light sources can be disposed around a vehicle providing 360-degree coverage. Each of the light sources can be referred to as a beacon and can be configured to emit modulated light conveying information that can permit vehicle positioning. In addition, 360-degree camera coverage about the car can be provided by functionally coupling a respective camera with each of such beacons. In other aspects, the embedded beacons can be operated in various modes, including a mode in which at least one of the embedded beacons can emit light in order to augment existing ambient light in order to assist with driving under certain environment conditions; and a second mode in which several of the embedded beacons can emit modulated light that can be accessed by other vehicles in order to determine cooperatively the relative position of the vehicles.

### BACKGROUND

In certain automotive applications, camera assisted driving can augment driver capabilities. For example, certain conventional camera-vision technology can be leveraged to warn of pending collision with objects (such as inanimate objects or pedestrians) and lane departure warning. Yet, such technologies usually lack precision in fast-changing driving scenarios, with the ensuing inadequate suitability to mitigate or avoid perils while driving.

### BRIEF DESCRIPTION OF THE DRAWINGS

The accompanying drawings are an integral part of the disclosure and are incorporated into the subject specification. The drawings illustrate example embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as limited to the implementations set forth herein. Like numbers refer to like, but not necessarily identical, elements throughout.

FIGS. 1-2A illustrate examples of a vehicular environment for vehicular positioning in accordance with one or more aspects of the disclosure.

FIG. 2B illustrates an example of transceiver configuration for vehicular positioning in accordance with one or more aspects of the disclosure.

FIG. 2C illustrates examples of vehicular coordinate system of reference for vehicular positioning in accordance with one or more aspects of the disclosure.

FIG. 2D illustrates example of multiple vehicular coordinate systems in accordance with one or more aspects of the disclosure.

FIG. 2E illustrates an example of a rotational matrix definition in accordance with one or more aspects of the disclosure.

FIG. 2F illustrates an example of multiple skewed coordinate systems in accordance with one or more aspects of the disclosure.

FIG. 2G illustrates an example of a definition of angular skew in accordance with one or more aspects of the disclosure.

FIG. 2H illustrates an example of a vehicular arrangement and related information in accordance with one or more aspects of the disclosure.

FIG. 3 illustrates an example of an operational environment for vehicular positioning in accordance with one or more aspects of the disclosure.

FIG. 4 illustrates an example of a computational environment for vehicular positioning in accordance with one or more aspects of the disclosure.

FIGS. 5-6 illustrate examples of methods for vehicular positioning in accordance with aspects of the disclosure.

### DETAILED DESCRIPTION

This disclosure recognizes and addresses, in at least certain aspects, the issue of assisted vehicular driving. More particularly, yet not exclusive, the disclosure provides systems, devices, and techniques that can provide vehicle positioning, which can be implemented in accordance with multiple modalities that permit or facilitate assisted driving. In certain modalities, the vehicle positioning in accordance with aspects of this disclosure may be referred to as “cooperative vehicle positioning” or “active one-way positioning” in that the relative position of a vehicle with respect to a second vehicle can be determined based on information received from the second vehicle and processed at the first vehicle. In this disclosure, the term “vehicle” refers to a machine with autonomous mobility having an enclosure (e.g., a cabin) that accommodates at least one operator. Such mobility can be provided by a combustion engine, a battery-operated engine, a hybrid (battery-combustion) engine, a fuel-cell-operated engine, a combination thereof, or the like. Aspects of the disclosure include vehicle positioning. In at least certain aspects, light sources (such as infrared sources) can be embedded or otherwise disposed around a vehicle (such as car) giving 360-degree coverage. Each of the light sources can be referred to as a beacon and can be configured to emit modulated light conveying information that can permit vehicle positioning. In addition, 360-degree camera coverage about the vehicle can be provided by functionally coupling a respective camera with each of such beacons. In other aspects, the embedded beacons can be operated in various modes. In one example mode, at least one of the embedded beacons can emit light (or electromagnetic radiation, which can be modulated or non-modulated) in order to augment existing ambient light in order to assist with driving under certain environment conditions (such as within a dart tunnel or at night, for example). As such, in one aspect, one or more photodetectors deployed (e.g., embedded or otherwise disposed) about a vehicle can detect or can be configured to detect electromagnetic radiation that is scattered off objects (including vehicles, for example) present in an environment of the vehicle. The electromagnetic radiation so detected can permit the assisted driving. In another example mode, one or several of the embedded beacons can emit modulated electromagnetic radiation that can be accessed by other vehicles in order to determine cooperatively the relative position of the vehicles. For example, a vehicle can access such radiation via photodetectors that are disposed about the vehicle, and can detect or can be configured to detect at least a portion the modulated electromagnetic radiation that is being emitted by another vehicle.

It should be appreciated that in at least certain embodiments, reliance on modulated electromagnetic radiation emitted by a vehicle for active one-way positioning in accordance with this disclosure can provide greater positioning range and/or accuracy. For instance, positioning range afforded by this active one-way positioning can span tens or hundreds of meters, depending on factors such as transmit power and/or path loss of the modulated electromagnetic radiation.

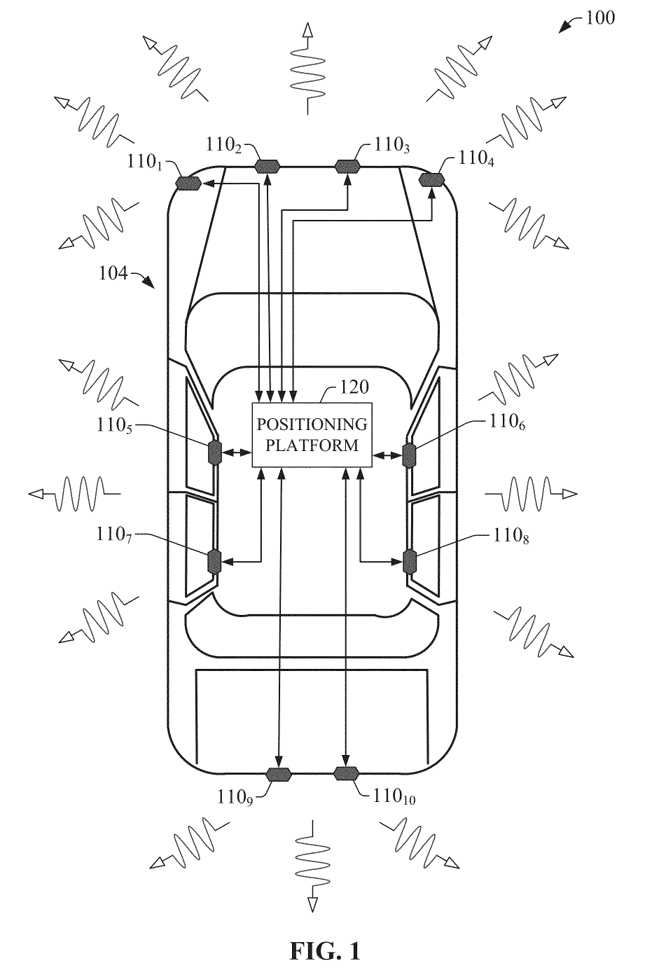

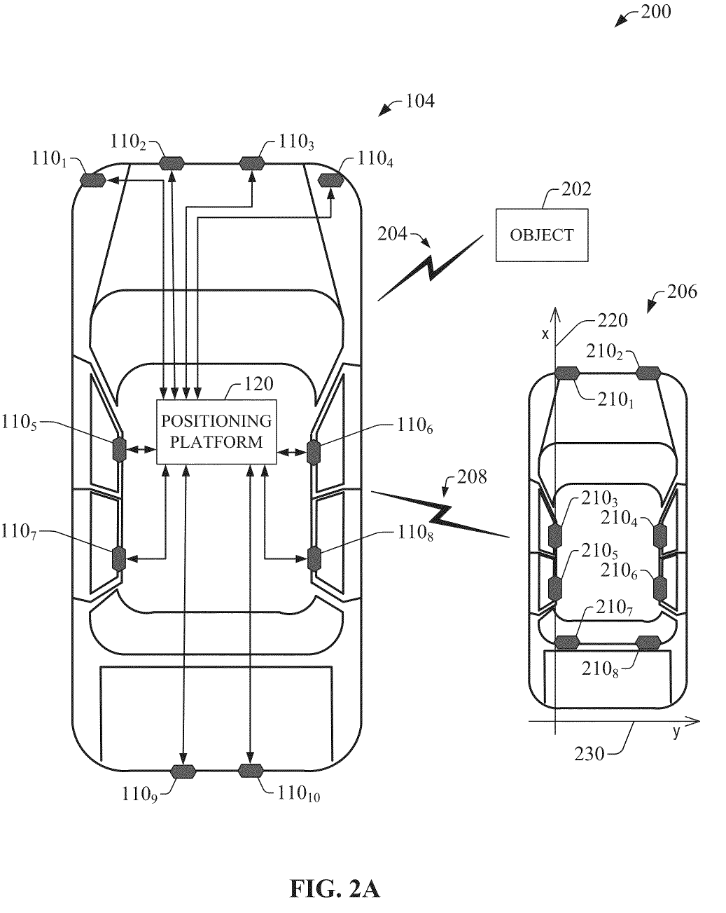

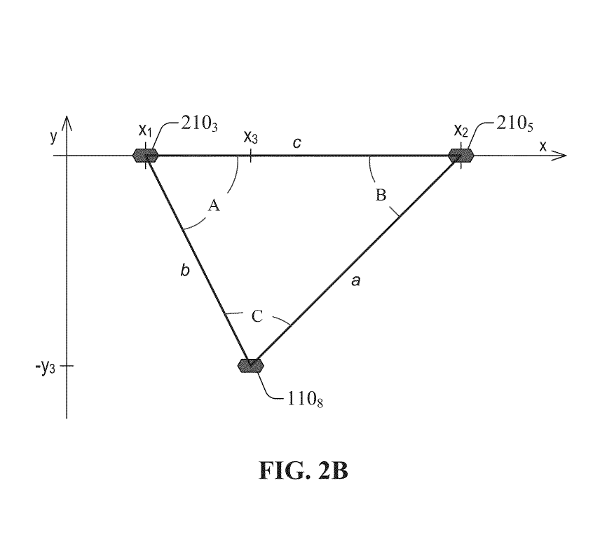

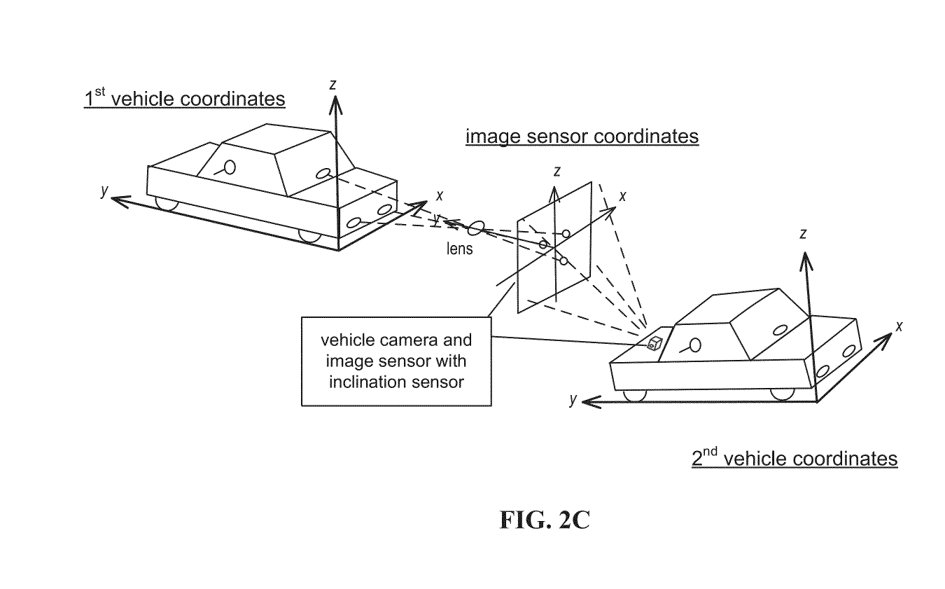

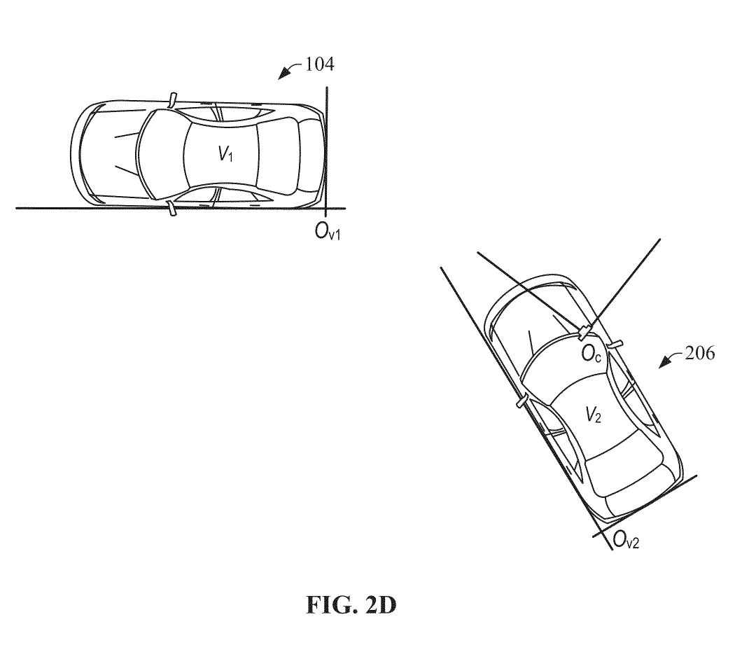

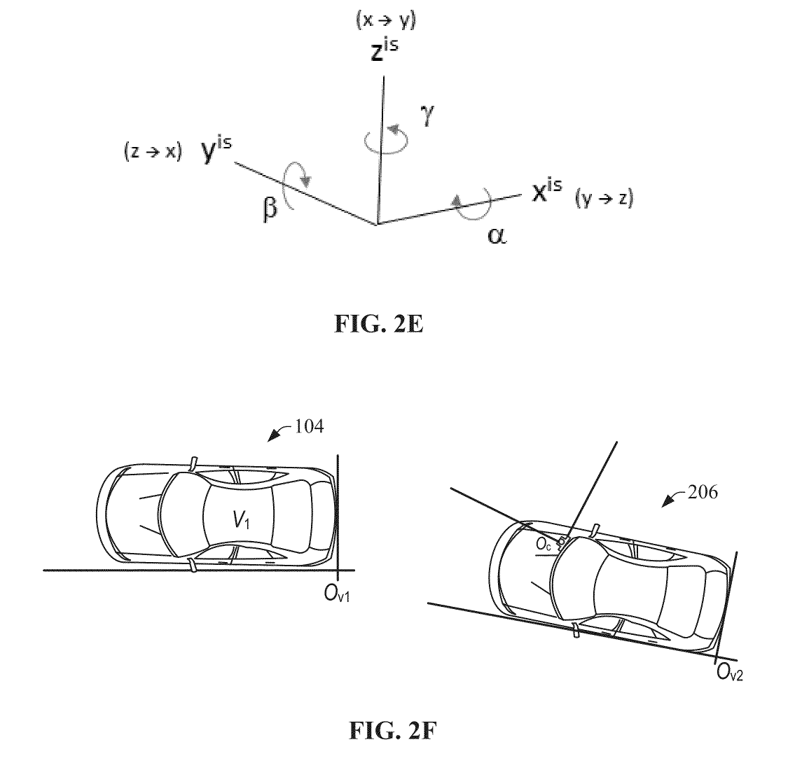

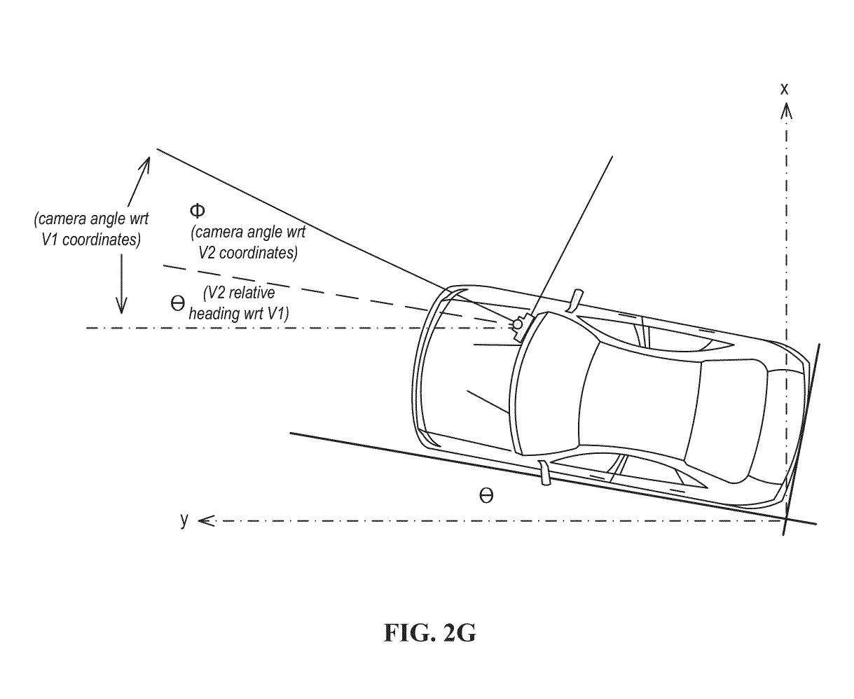

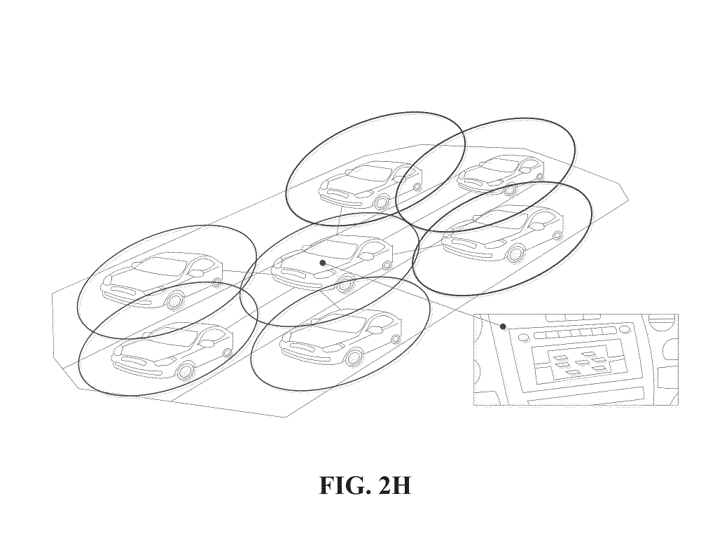

With reference to the drawings, FIGS. 1-2 illustrate examples of a vehicular environment in accordance with one or more aspects of the disclosure. As illustrated in FIG. 1, the vehicular environment 100 includes a vehicle 104 that includes a group of transceivers 110₁-110₁₀ and a positioning platform 120. It should be appreciated that while ten transceivers are depicted, the disclosure is not so limited and contemplates substantially any number of sensors. The group of transceivers 110₁-110₁₀ can be deployed (e.g., installed; configured; accepted; installed and accepted; configured and accepted; installed, configured, and accepted; or the like) within or in proximity to the cabin of the vehicle 104 (see, e.g., transceivers 110₅-110₈) or outside the cabin (e.g., transceivers 110₁-110₄ and 110₉-110₁₀). In certain embodiments, the group of transceivers can be disposed or otherwise embedded around the vehicle 104 in an assembly that can provide transmission and/or reception of signal in 360-degree coverage. At least a portion of the group of transceivers 110₁-110₁₀ can collect or can be configured to collect electromagnetic radiation. For example, each of the transceivers in at least such portion of the group of transceivers 110₁-110₁₀ can be embodied in or can include a photodetector (e.g., a charge-coupled device (CCD) camera, an active-pixel sensor (APS), or other type of semiconductor-based camera, a combination thereof, or the like.). In certain embodiments, such photodetector(s) can detect light at high speed or at a high-frame rate, which can range from about to 200 frames per second to about 20000 frames per seconds, for example. It should be recognized that such frame rates are illustrative and higher or lower frame rates can be contemplated or otherwise relied upon in this disclosure. In certain embodiments, at least one of the photodetector(s) can include a camera that can collect or otherwise detect light at a frame rate that is at least about two orders of magnitude greater than a conventional camera for visible light. While not depicted, in certain embodiments, each of the one or more photodetectors that can be contained in the group of transceivers 110₁-110₁₀ can be functionally coupled to an inclination sensor that can determine or can be configured at least to determine or otherwise probe the inclination (or pose) of a respective photodetector.

In addition, a second portion of the group of transceivers 110₁-110₁₀ can emit or can be configured to emit electromagnetic radiation. In one aspect, each of the transceivers in at least the second portion of the group of transceivers 110₁-110₁₀ can be embodied in or can include at least one light source (e.g., a high-power light emitting diode (LED), a halogen lamp, a combination thereof, or the like) that can emit light in a specific portion of the electromagnetic (EM) spectrum. As an illustration, such light source(s) can emit electromagnetic radiation substantially in the infrared portion of the EM spectrum, which can mitigate distraction of operators of other vehicles in proximity to the vehicle 104. The light (or electromagnetic radiation) emitted by one or more of the light sources in the group of transceivers 110₁-110₁₀ is represented as curvy arrows in FIG. 1. In certain embodiments, each of the transceivers can be embodied in or can include a device that integrates a photodetector and a light source (e.g., an LED). It should be appreciated that the light source in such a device can be configured or otherwise assembled to avoid saturation of the associated photodetector while permitting the photodetector to collect or otherwise detect light from an environment illuminated by the light source.

The transceivers 110₁-110₁₀ can be functionally coupled to the positioning platform 120. Such functional coupling (e.g., communicative coupling, electrical coupled, mechanical coupling, electromechanical coupling, a combination thereof, or the like) can permit the exchange of information (e.g., data, metadata, and/or signaling) between at least one transceiver of the group of transceivers 110₁-110₁₀ and the positioning platform 120. The information can be exchanged in digital format and/or analogic format. As such, in one aspect, the positioning platform 120 can access imaging information from one or more cameras contained in the group of transceivers 110₁-110₁₀, where at least such information can be representative or otherwise indicative of an environment of the vehicle 104.

In addition, the positioning platform 120 can configure (e.g., generate and/or provision an operational setting for) one or more of the light source(s) that can be contained in the group of transceivers 110₁-110₁₀ to operate in various modes. In one example mode, which herein may be referred to as “collision avoidance mode,” the positioning platform 120 can configure at least one light source to emit radiation (which can be modulated or non-modulated). In an embodiment in which the at least one source contains multiple light sources disposed about the vehicle 104, emission of the modulated light can produce a light field that can be utilized or otherwise leveraged to augment any ambient light or illuminate a dark environment of the vehicle 104. For example, each transceiver in the group of transceivers 110₁-110₁₀ can include a light source, such a high-power LED, that can emit radiation (which can be modulated or non-modulated), which may provide substantially 360-degree illumination coverage about the vehicle 104. In addition, when the group of transceivers 110₁-110₁₀ includes multiple photodetectors that can collect or otherwise detect electromagnetic radiation that is reflected or otherwise scattered off objects in the environment of the vehicle 104 in response to emission of the radiation, the multiple photodetectors can permit probing such an environment. For instance, as illustrated in the example vehicular environment 200 shown in FIG. 2, the emitted light can be scattered off (e.g., reflected off) an object 202 and the photodetectors associated with the transceivers 110₄, 110₆, and 110₈ can collect or otherwise detect the scattered light, which is generically represented with a lightning bolt 204. In certain implementations, the described multiple photodetectors can be arranged to provide substantially 360-degree coverage for collection of reflected or scattered off electromagnetic radiation in the environment of the vehicle 104. Accordingly, in the collision avoidance mode, the group of transceivers 110₁-110₁₀ can include light sources (which herein may be referred to as beacons) and photodetectors that can permit collision avoidance in substantially any environment irrespective of ambient illumination conditions.

In another example mode of operation, which herein may be referred to as “active positioning mode,” the positioning platform 120 can configure at least one light source to emit modulated electromagnetic radiation. In one aspect, the modulated radiation can be convey information indicative of an identity or identification (ID) of the vehicle 104 (e.g., a vehicle identification number (VIN) or a custom code) and/or information indicative of the respective location of each light source that emits at least a portion of the modulated radiation. Such respective location(s) can be established and/or conveyed in coordinates relative to a reference frame in the vehicle 104. Therefore, in certain embodiments, the positioning platform 120 can configure the at least one light source to switch controllably between an ON (or emitting) state and an OFF (or non-emitting) state. In addition, the positioning platform 120 can modulate an ON/OFF signal that switches the at least one light source between ON and OFF states. In addition, via the modulated ON/OFF switching, which may be referred to as ON/OFF keying, the positioning platform 120 can compose or otherwise format the information conveyed in the electromagnetic radiation into packets, which therefore, can be communicated via the electromagnetic radiation. As such, the information can be packetized and, in one aspect, the packets can include at least one packet including a respective first frame including payload data indicative of ID of the vehicle 104, and a respective second frame including second payload data indicative of the location of at least one light source that emits at least a portion of the modulated electromagnetic radiation.

In addition, in the active positioning mode, the positioning platform 120 can receive information conveyed in similarly modulated electromagnetic radiation. To at least such an end, in one aspect, the positioning platform 120 can process (e.g., demodulate) information received from at least one of the camera(s) that can be contained in the group of transceivers 110₁-110₁₀. In certain scenarios, the modulated electromagnetic radiation that can convey the information processed by the positioning platform 120 can be emitted by another vehicle, such as vehicle 206 in the operational environment 200 illustrated in FIG. 2A. For instance, the vehicle 206 can include a group of transceivers 210₁-210₈ that can include one or more cameras that can emit the modulated electromagnetic radiation, which is represented in FIG. 2A as a lightning bolt 208. More particularly, yet not exclusively, transceivers 210₃ and 210₅ can emit at least a portion of the modulated electromagnetic radiation, and at least transceiver 110₈ can detect such electromagnetic radiation. In one aspect, such modulated electromagnetic radiation can convey information indicative of an identification of the vehicle 206 (e.g., a VIN or a custom code) and/or information indicative of the respective location of at least one of the one or more light sources that emit at least a portion of the modulated electromagnetic radiation.

Further, in active positioning mode, the positioning platform 120 can determine a location of a light source in vehicle 206 based at least on information conveyed in the modulated electromagnetic radiation emitted by the light source. As described herein, in one aspect, the location of such a light source can be conveyed in coordinates relative to a reference frame in the vehicle 206. For instance, the reference frame can be defined by two orthogonal axes 220 and 230, which may be referred to as “x axis” and “y axis,” respectively. Based at least on the respective locations of one or more light sources in the vehicle 206 (such as the positions of two light sources respectively associated with the transceivers 210₃ and 210₅), the positioning platform 120 can determine a position of the vehicle 104 relative to the vehicle 206. To at least such an end, in certain embodiments, the positioning platform 120 can configure each of such one or more light sources as a respective anchor point, thereby yielding one or more anchor photogrammetry feature points (each of which herein may be referred to as “anchor points”). The positioning platform 120 also can access (e.g., receive or otherwise acquire) information indicative of the inclination of a photodetector that collects or otherwise receives at least a portion of the modulated electromagnetic radiation emitted by the one or more light sources in the vehicle 206. In addition, the positioning platform 120 can determine the position of the vehicle 104 relative to the vehicle 206 via photogrammetry based at least on (A) the location of the one or more anchor points (e.g., the anchor points related to transceivers 210₃ and 210₅), and (B) the respective inclination of the photodetector that collects or otherwise receives at least a portion of the modulated electromagnetic radiation. As an illustration, FIG. 2B presents an example of a configuration of transceivers that permit determination of such a relative position between vehicles. In such an example, the transceiver 1108 associated with vehicle 104 can receive modulated electromagnetic radiation from respective light sources associated with (e.g. integrated into) transceivers 210₃ and 210₅ associated with vehicle 206. The identification of the transceivers 210₃ and 210₅ as anchor points can provide at least an estimate of angles A and B. Therefore, in one aspect, angle C can be estimated from A and B as follows: C=π−A−B. Based on such a determination, the positioning platform 120 can determine an estimate of the length of segments a and b:

$$b = sin ( B ) \frac{c}{sin ( C )} and α = sin ( A ) \frac{c}{sin ( C )} .$$

Here, the length of segment c can be computed as the difference between x₂ and x₁, which are coordinates received in the modulated electromagnetic radiation emitted by transceiver 210₅ and 210₃, respectively. As such, in one aspect, the positioning platform 120 can determined the relative position (x3, y3) of vehicle 104 with respect to vehicle 206 as follows:

$${x}_{3} = {x}_{1} + \sqrt{{b}^{2} - {y}_{3}^{2}} and {y}_{3} = - \frac{\sqrt{s ( s - a ) ( s - b ) ( s - c )}}{c} .$$

FIGS. 2C-2G present an example of a formalism of photogrammetric positioning that the positioning platform 120 can implement in order to determine relative position between vehicles in accordance with aspects of this disclosure. As described herein, in certain aspects of the disclosure, multiple visual features (herein referred to as “anchor points) can be determined (e.g., observed and/or classified). As described herein, such visual features can correspond to light sources (e.g., LED lights) having known positions within a vehicle that can be observed from another vehicle. The availability of such multiple visual features can permit the positioning platform 120 or a component thereof to ascertain the position of each light source relative to the plurality of light sources (which may be referred to as a constellation. As described herein, each vehicle in accordance with aspects of the disclosure can define specific respective coordinate systems. In addition, one or more sensor coordinate systems associated with at least one image sensor (e.g., a photodetector) also can be included.

In certain scenarios, it can be considered that two vehicles (e.g., vehicle 104 and 206) that are configured and utilize vehicle positioning in accordance with aspects of this disclosure can be located in the same plane. In addition, by way of simplification of the formalism and not limitation thereof, the terrain in which the vehicles operate can be reasonably flat. As described herein and illustrated in FIG. 2D, the location of the origin of coordinate system of a first vehicle (e.g., the vehicle 206) with respect to the origin of the coordinate system of a second vehicle (e.g., the vehicle 104) can be determined via a coordinate system of an image sensor based at least on a series of coordinate transformations that can begin with the image sensor coordinate system.

In one aspect, the image sensor can be embodied in a two-dimensional component which can be mapped to three dimensions via information from an inclination sensor that can be embedded or otherwise functionally coupled to the image sensor (e.g., a camera or photodetector). The location of the image sensor can be mapped to the coordinated system of the second vehicle (e.g., vehicle 104), and based on the location of the image sensor in the coordinate system of the second vehicle (e.g., vehicle 206), the position of the first vehicle (e.g., vehicle 104) with respect to the second vehicle (e.g., vehicle 206) can be determined.

Without intended to be bound by theory and/or simulation, it should be appreciated that there are three coordinate systems involved in the coordinate transformations described herein: (i) the image sensor coordinates (IS coordinates); the first vehicle coordinates (V₂ coordinates) and the second vehicle coordinates (V₁ coordinates). As described herein, in one embodiment, an example process for vehicle positioning in accordance with aspects of this disclosure can include the following: (1) Determining the manner in which the light sources (e.g., LED lights), with known locations in the V₁ coordinate system, can illuminate the pixels on the image sensor. (2) Leveraging or otherwise utilizing the inclination sensor to map the illuminated pixels from the two-dimensional image sensor to IS coordinates. (3) Solving photogrammetry collinearity equations based at least on observing multiple light sources (e.g., LED lights), and determining the location of the image sensor in V₁ coordinates based on the solved photogrammetry collinearity equations. (4) Determining the position of the first vehicle (e.g., vehicle 206) with respect to the second vehicle (e.g., vehicle 104).

In one implementation, the positioning platform 120 can transform the coordinates of the i-th anchor feature in the second vehicle (e.g., vehicle 104)—which can be denoted as vector Pᵢ₍ᵥ₁₎=<Pᵢ₍ᵥ₁₎^{X},Pᵢ₍ᵥ₁₎^{Y},Pᵢ₍ᵥ₁₎^{Z}>^{T}—to image sensor (IS) coordinates via a linear transformation including an origin translation (O_{C(v1)}) and a rotation (R_{C}).

Pᵢ₍ᵥ₁₎=O_{C(v1)}+R_{C}P_{i(C)}, Eq. (1)

where O_{C(v1)} is the origin of the image sensor coordinate system in coordinates of the second vehicle (e.g., vehicle 104), and R_{C} is the orientation rotational matrix associated with the pose of the image sensor. It should be appreciated that the origin of the camera coordinate system in coordinates of the second vehicle (which may be referred to as V1 coordinates) may be unknown and may be which is considered to be at the focal point of a camera lens that may be embedded or otherwise associated with the image sensor. Similarly, the pose of the image sensor may be unknown. In one aspect, the rotational matrix can be defined with respect to the image sensor coordinates as described herein, e.g., via an inclination sensor that can be functionally coupled and/or attached to the camera or image sensor.

In certain embodiments, the camera rotation matrix can be defined as R_{C}=R_{C}^{z}(γ)·R_{C}^{x}(α)·R_{C}^{y}(β), where

$${R}_{C}^{X} ( α ) = [ \begin{matrix}1 & 0 & 0 \\ 0 & cos α & - sin α \\ 0 & sin α & cos α\end{matrix} ]$$

$${R}_{C}^{Y} ( β ) = [ \begin{matrix}cos β & 0 & sin β \\ 0 & 1 & 0 \\ - sin β & 0 & cos β\end{matrix} ]$$

$${R}_{C}^{Z} ( γ ) = [ \begin{matrix}cos γ & - sin γ & 0 \\ sin γ & cos γ & 0 \\ 0 & 0 & 1\end{matrix} ] .$$

FIG. 2E illustrates the rotations associated with angles α, β, and γ. The value of α and β can be determined or otherwise obtained directly from measurements by an inclination sensor associated with (e.g., integrated into or functionally coupled to) the image sensor. The value of γ is to be solved or otherwise determined because it provides the azimuth angle of the image sensor (e.g., a camera or photodetector) with respect to the V₁ coordinate system. Therefore, in one aspect, the following relationships can be introduced: R_{C}^{I}=R_{C}^{X}(α)·R_{C}^{Y}(β) and R_{C}^{A}=R_{C}^{z}(γ). Without intending to be bound by theory and/or simulation, it should be appreciated that while the sub-matrices of a rotation matric are unique, the rotational matrix itself may not be unique because the matrix multiplication is not commutative. Therefore, in one aspect, the rotation matrix may be ambiguous.

In one aspect, in order to form linear equations to represent the transformations of coordinate described herein, the following variable may be defined: p=cos γ and σ=sin γ. Therefore, in one aspect, azimuth rotation matrix associated with the image sensor (e.g., a photodetector or camera) can be expressed as:

$${R}_{C}^{A} ( γ ) = [ \begin{matrix}ρ & - σ & 0 \\ σ & ρ & 0 \\ 0 & 0 & 1\end{matrix} ] \qquad Eq . ( 2 )$$

The orthogonal matrix properties of (R_{C}^{I})⁻¹=(R_{C}^{I})^{T} and (R_{C}^{A})⁻¹=(R_{C}^{A})^{T} can be leveraged to recast Eq. (1) as:

$${R}_{i ( C )} = {( {R}_{C} )}^{- 1} \cdot {P}_{i ( v 1 )} + {O}_{v 1 ( C )} = {( {R}_{C}^{I} )}^{T} \cdot [ \begin{matrix}ρ & σ & 0 \\ - σ & ρ & 0 \\ 0 & 0 & 1\end{matrix} ] \cdot {P}_{i ( v 1 )} + {O}_{v 1 ( C )} , \qquad Eq . ( 3 )$$

which can be expanded as follows:

$$[ \begin{matrix}{P}_{i ( C )}^{X} \\ {P}_{i ( C )}^{Y} \\ {P}_{i ( C )}^{Z}\end{matrix} ] = [ \begin{matrix}{r}_{C ( 11 )}^{I} & {r}_{C ( 21 )}^{I} & {r}_{C ( 31 )}^{I} \\ {r}_{C ( 12 )}^{I} & {r}_{C ( 22 )}^{I} & {r}_{C ( 32 )}^{I} \\ {r}_{C ( 13 )}^{I} & {r}_{C ( 23 )}^{I} & {r}_{C ( 33 )}^{I}\end{matrix} ] \cdot [ \begin{matrix}ρ & σ & 0 \\ - σ & ρ & 0 \\ 0 & 0 & 1\end{matrix} ] \cdot [ \begin{matrix}{P}_{i ( v 1 )}^{X} \\ {P}_{i ( v 1 )}^{Y} \\ {P}_{i ( v 1 )}^{Z}\end{matrix} ] + [ \begin{matrix}{O}_{v 1 ( C )}^{X} \\ {O}_{v 1 ( C )}^{Y} \\ {O}_{v 1 ( C )}^{Z}\end{matrix} ] \\ {where \\ ( {R}_{C}^{I} )}^{T} = [ \begin{matrix}{r}_{C ( 11 )}^{I} & {r}_{C ( 21 )}^{I} & {r}_{C ( 31 )}^{I} \\ {r}_{C ( 12 )}^{I} & {r}_{C ( 22 )}^{I} & {r}_{C ( 32 )}^{I} \\ {r}_{C ( 13 )}^{I} & {r}_{C ( 23 )}^{I} & {r}_{C ( 33 )}^{I}\end{matrix} ] . \qquad Eq . ( 4 )$$

In one aspect, Eq. (4) can be rewritten as follows:

P_{i(C)}^{X}=(r_{C(11)}^{I}·Pᵢ₍ᵥ₁₎^{X}+r_{C(21)}^{I}·Pᵢ₍ᵥ₁₎^{Y})·ρ+(r_{C(11)}^{I}·Pᵢ₍ᵥ₁₎^{Y}−r_{C(21)}^{I}·Pᵢ₍ᵥ₁₎^{X})·σ+(r_{C(31)}^{I}·Pᵢ₍ᵥ₁₎^{Z})+O_{v1(C)}^{X}

P_{i(C)}^{Y}=(r_{C(12)}^{I}·Pᵢ₍ᵥ₁₎^{X}+r_{C(22)}^{I}·Pᵢ₍ᵥ₁₎^{Y})·ρ+(r_{C(12)}^{I}·Pᵢ₍ᵥ₁₎^{Y}−r_{C(22)}^{I}·Pᵢ₍ᵥ₁₎^{X})·σ+(r_{C(32)}^{I}·Pᵢ₍ᵥ₁₎^{Z})+O_{v1(C)}^{Y}.

P_{i(C)}^{Z}=(r_{C(13)}^{I}·Pᵢ₍ᵥ₁₎^{X}+r_{C(23)}^{I}·Pᵢ₍ᵥ₁₎^{Y})·ρ+(r_{C(13)}^{I}·Pᵢ₍ᵥ₁₎^{Y}−r_{C(23)}^{I}·Pᵢ₍ᵥ₁₎^{X})·σ+(r_{C(33)}^{I}·Pᵢ₍ᵥ₁₎^{Z})+O_{v1(C)}^{Z} Eq. (5)

In should be appreciated that Eq. (5) is a set of three linear equations that contains eight unknown parameters. Therefore, in one aspect, at least three anchor features (e.g., light sources) can be probed or otherwise observed in order to obtain a solution. In certain implementations, in a scenario in which more than three lights are observed, averaging can be applied in order to decrease computational errors.

Without intending to be bound by theory and/or modeling, the nomenclature herein can be simplified by defining

$$\begin{matrix}{S}_{i} = [ \begin{matrix}{s}_{1 ( i )} & {s}_{2 ( i )} & {s}_{3 ( i )} \\ {s}_{4 ( i )} & {s}_{5 ( i )} & {s}_{6 ( i )} \\ {s}_{7 ( i )} & {s}_{8 ( i )} & {s}_{9 ( i )}\end{matrix} ] \\ = [ \begin{matrix}( \begin{matrix}{r}_{C ( 11 )}^{I} \cdot {P}_{i ( v 1 )}^{X} + \\ {r}_{C ( 21 )}^{I} \cdot {P}_{i ( v 1 )}^{Y}\end{matrix} ) & ( {r}_{C ( 11 )}^{I} \cdot {P}_{i ( v 1 )}^{Y} + {r}_{C ( 21 )}^{I} \cdot {P}_{i ( v 1 )}^{X} ) & {r}_{C ( 31 )}^{I} \cdot {P}_{i ( v 1 )}^{Z} \\ ( \begin{matrix}{r}_{C ( 13 )}^{I} \cdot {P}_{i ( v 1 )}^{X} + \\ {r}_{C ( 23 )}^{I} \cdot {P}_{i ( v 1 )}^{Y}\end{matrix} ) & ( {r}_{C ( 13 )}^{I} \cdot {P}_{i ( v 1 )}^{Y} + {r}_{C ( 23 )}^{I} \cdot {P}_{i ( v 1 )}^{X} ) & {r}_{C ( 33 )}^{I} \cdot {P}_{i ( v 1 )}^{Z} \\ ( \begin{matrix}{r}_{C ( 12 )}^{I} \cdot {P}_{i ( v 1 )}^{X} + \\ {r}_{C ( 22 )}^{I} \cdot {P}_{i ( v 1 )}^{Y}\end{matrix} ) & ( {r}_{C ( 12 )}^{I} \cdot {P}_{i ( v 1 )}^{Y} + {r}_{C ( 22 )}^{I} \cdot {P}_{i ( v 1 )}^{X} ) & {r}_{C ( 32 )}^{I} \cdot {P}_{i ( v 1 )}^{Z}\end{matrix} ]\end{matrix}$$

where the matrix Sᵢ is unique for each of the light features. In one aspect, Eq. (5) can be recast as follows:

P_{i(C)}^{X}=s₁₍ᵢ₎·ρ+s₂₍ᵢ₎·σ+s₃₍ᵢ₎+O_{v1(C)}^{X}

P_{i(C)}^{Y}=s₇₍ᵢ₎·ρ+s₈₍ᵢ₎·σ+s₉₍ᵢ₎+O_{v1(C)}^{Y}.

P_{i(C)}^{Z}=s₄₍ᵢ₎·ρ+s₅₍ᵢ₎·σ+s₆₍ᵢ₎+O_{v1(C)}^{Z} Eq. (6)

Based at least on the transformed position vector of the i-th anchor feature, the collinearity equations that describe the projection of the light features onto the two dimensional image sensor can be defined as follows:

$$\begin{matrix}{IS}_{i ( C )}^{X} = - f \frac{{P}_{i ( C )}^{X}}{{P}_{i ( C )}^{Y}} = - f \frac{{s}_{1 ( i )} \cdot ρ + {s}_{2 ( i )} \cdot σ + {s}_{3 ( i )} + {O}_{v 1 ( C )}^{X}}{{s}_{7 ( i )} \cdot ρ + {s}_{8 ( i )} \cdot σ + {s}_{9 ( i )} + {O}_{v 1 ( C )}^{Y}} & Eq . ( 7 ) \\ {IS}_{i ( C )}^{Z} = - f \frac{{P}_{i ( C )}^{Z}}{{P}_{i ( C )}^{Y}} = - f \frac{{s}_{4 ( i )} \cdot ρ + {s}_{5 ( i )} \cdot σ + {s}_{6 ( i )} + {O}_{v 1 ( C )}^{Z}}{{s}_{7 ( i )} \cdot ρ + {s}_{8 ( i )} \cdot σ + {s}_{9 ( i )} + {O}_{v 1 ( C )}^{Y}} . & Eq . ( 8 )\end{matrix}$$

where f is the lens focal length of the image sensor (e.g., a camera or photodetector). Without intending to be bound by theory or modeling, it should be appreciated that the collinearity equations (7) and (8) normalize the “Y” component of the transformed position vectors because the image sensor (e.g., a camera or photodetector) lies the in X-Z plane with the Y axis projecting through the lens focal point.),

The values on the left side of Eq. (7) and Eq. (8) can be obtained from directly reading the image sensor (e.g., a photodetector). In one aspect, Eq. (7) and Eq. (8) can be reorganized into two linear equations as follows:

(IS_{i(C)}^{X}·s₇₍ᵢ₎+f·s₁₍ᵢ₎)·ρ+(IS_{i(C)}^{X}·s₈₍ᵢ₎+f·s₂₍ᵢ₎)·σ+f·O_{v1(C)}^{X}+IS_{i(C)}^{X}·O_{v1(C)}^{X}=−f·s₃₍ᵢ₎−IS_{i(C)}^{X}·s₉₍ᵢ₎

(IS_{i(C)}^{Z}·s₇₍ᵢ₎+f·s₄₍ᵢ₎)·ρ+(IS_{i(C)}^{Z}·s₈₍ᵢ₎+f·s₅₍ᵢ₎)·σ+IS_{i(C)}^{Z}·O_{v1(C)}^{X}+f·O_{v1(C)}^{Z}=−f·s₆₍ᵢ₎−IS_{i(C)}^{Z}·s₉₍ᵢ₎ Eq. (9)

which can be recast in matrix form as

$$[ \begin{matrix}{IS}_{i ( C )}^{X} \cdot {s}_{7 ( c )} + f \cdot {s}_{1 ( i )} & {IS}_{i ( C )}^{X} \cdot {s}_{8 ( i )} + f \cdot {s}_{2 ( i )} & f & {IS}_{i ( C )}^{X} & 0 \\ {IS}_{i ( C )}^{Z} \cdot {s}_{7 ( i )} + f \cdot {s}_{4 ( i )} & {IS}_{i ( C )}^{Z} \cdot {s}_{8 ( i )} + f \cdot {s}_{5 ( i )} & 0 & {IS}_{i ( C )}^{Z} & f\end{matrix} ] [ \begin{matrix}ρ \\ σ \\ {O}_{v 1 ( C )}^{X} \\ {O}_{v 1 ( C )}^{Y} \\ {O}_{v 1 ( C )}^{Z}\end{matrix} ] = [ \begin{matrix}- f \cdot {s}_{3 ( i )} - {IS}_{i ( C )}^{X} \cdot {s}_{9 ( i )} \\ - f \cdot {s}_{6 ( i )} - {IS}_{i ( C )}^{Z} \cdot {s}_{9 ( i )}\end{matrix} ] \qquad Eq . ( 10 )$$

In one aspect, Eq. (10) can be expressed as

Aᵢ·p=bᵢ Eq. (11)

where

$${A}_{i} = [ \begin{matrix}{IS}_{i ( C )}^{X} \cdot {s}_{7 ( i )} + f \cdot {s}_{1 ( i )} & {IS}_{i ( C )}^{X} \cdot {s}_{8 ( i )} + f \cdot {s}_{2 ( i )} & f & {IS}_{i ( C )}^{X} & 0 \\ {IS}_{i ( C )}^{Z} \cdot {s}_{7 ( i )} + f \cdot {s}_{4 ( i )} & {IS}_{i ( C )}^{Z} \cdot {s}_{8 ( i )} + f \cdot {s}_{5 ( i )} & 0 & {IS}_{i ( C )}^{Z} & f\end{matrix} ]$$

$$p = [ \begin{matrix}ρ \\ σ \\ {O}_{v 1 ( C )}^{X} \\ {O}_{v 1 ( C )}^{Y} \\ {O}_{v 1 ( C )}^{Z}\end{matrix} ] , and$$

$${b}_{i} = [ \begin{matrix}- f \cdot {s}_{3 ( i )} - {IS}_{i ( C )}^{X} \cdot {s}_{9 ( i )} \\ - f \cdot {s}_{6 ( i )} - {IS}_{i ( C )}^{Z} \cdot {s}_{9 ( i )}\end{matrix} ] .$$

The elements of vector O_{v1(c)} (e.g., the V₁ origin expressed in image sensor (IS) coordinates) and the elements of the azimuth rotation matrix R_{C}^{A}(γ) can be directly determined or otherwise obtained from the solved vector p, which allows us to determine the complete rotational matrix R_{C}=R_{C}^{Z}(γ)·R_{C}^{X}(α)·R_{C}^{Y}(β) where

$$γ = atan 2 ( \frac{σ}{ρ} ) .$$

Therefore, the desired image sensor origin can be determined with respect to coordinates V₁ as

O_{C(v1)}=−R_{C}·O_{v1(C)}. Eq. (12)

The pose of the first vehicle V₂ (e.g., vehicle 206) is to be determined with respect to the second vehicle V₁ (e.g., vehicle 104). Without intending to be limited by theory and/or modeling, such a determined can be performed more simply by assuming that the first and second vehicles operate on reasonably flat terrain. While such assumption generally is adequate, it should be recognized that it is not necessary and it can be readily relaxed in order to determine the pose more generally.

FIG. 2F illustrates three coordinate systems: (i) V₁ with origin at Oᵥ₁, (ii) V₂ with origin at Oᵥ₂, and (iii) the camera with origin at O_{C}. It should be appreciated that all three coordinate systems may be angularly skewed with respect to each other. It should be appreciated that while the image sensor (e.g., a camera or photodetector) can be randomly positioned on a vehicle, the azimuth angular skew is assumed to be known or otherwise available.

FIG. 2G illustrates the angles that are determined in order to establish the relative position of a first vehicle (e.g., vehicle 206) relative to a second vehicle (e.g., vehicle 104). In one aspect, the relative heading of vehicle V₂ with respect to vehicle V₁ is to be determined. Such a heading angle is represented as by angle θ in FIG. 2G. From such a drawing it can be determined that that θ=γ−φ, which can permit defining an azimuth rotational matrix associated with the first vehicle (e.g., vehicle 206) as follows:

$${R}_{v 2}^{A} ( θ ) = [ \begin{matrix}cos θ & - sin θ & 0 \\ sin θ & cos θ & 0 \\ 0 & 0 & 1\end{matrix} ] .$$

Therefore, the location of the first vehicle's origin can be determined in the coordinate system of the second vehicle (e.g., vehicle 104) as follows:

Oᵥ₂₍ᵥ₁₎=O_{C(v1)}−Rᵥ₂⁻¹(θ)·O_{C(v2)}=−R_{C}·O_{v1(C)}−Rᵥ₂⁻¹(θ)·O_{C(v2)}. Eq. (13)

In one scenario, as illustrated in FIG. 2H, a group of vehicles, each having a positioning platform and at least one transceiver in accordance with one or more aspects of this disclosure, can determine relative vehicle positions cooperatively in that modulated electromagnetic radiation emitted form one or more vehicles in the group and conveying in-vehicle location of the source(s) of such radiation can be utilized or otherwise leveraged by a second vehicle in the group in order to establish a map or spatial arrangement of the one or more vehicles. Such a map may be conveyed in a rendering device, such as a navigation interface, of the second vehicle, which can assist in operation of the second vehicle. In certain embodiments, alerts (e.g., sounds) or other indications may be conveyed (e.g., emitted) by a device within the cabin in the second vehicle when at least one of the one or more vehicles is at a predetermined distance of the second vehicle.

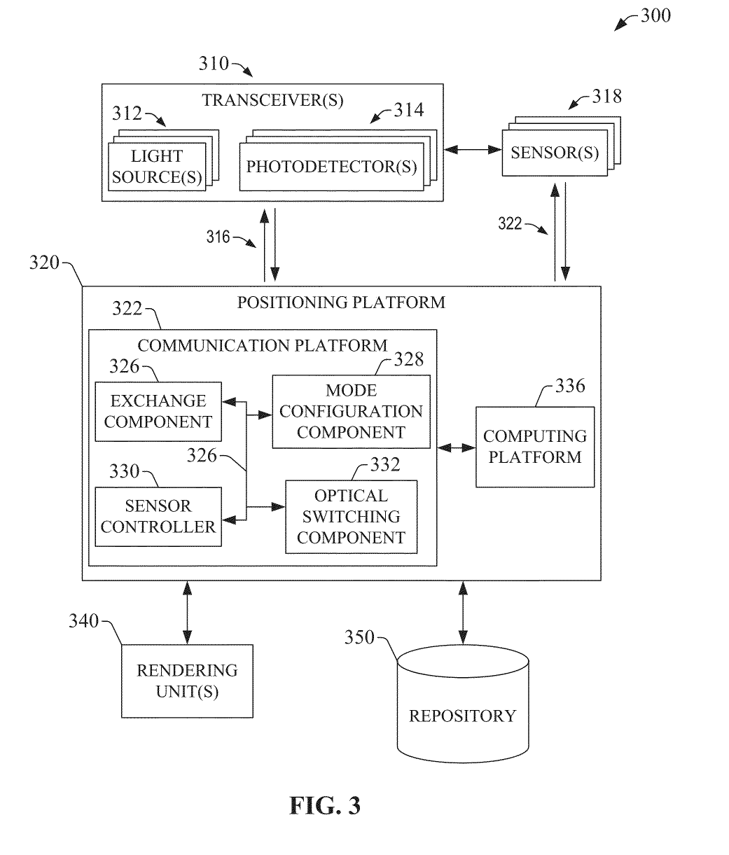

FIG. 3 illustrates a block diagram of an example operational environment 300 for vehicular positioning in accordance with one or more aspects of the disclosure. As illustrated, the positioning platform 120 can be functionally coupled to a group of one or more transceivers 310, which can be disposed or otherwise embedded around a vehicle (e.g., vehicle 104 or vehicle 206). The transceiver(s) 310 can include one or more light sources 312 and one or more photodetectors 314. While the light source(s) 312 and the photodetector(s) 314 are illustrated as separate blocks, in certain embodiments, at least a portion of the light source(s) 312 and at least a portion of the photodetector(s) 314 can be integrated into a single functional block (e.g., a unit or component). As described herein, each of the light source(s) 312 can be referred to as beacon and can emit light in a specific region of the electromagnetic spectrum (e.g., such as the IR region). At least one (e.g., one, two, more than two, or each) of the light source(s) 312 can be embodied in or can include a high-power LED, a halogen lamp, or the like. In addition, at least one of the photodetector(s) 314 can be embodied in or can include a CCD camera, an APS, other type of semiconductor-based camera, a combination thereof, or the like. In one example, the one or more transceivers 310 (which herein may be referred to as transceiver(s) 310) can embody or can constitute the group of transceivers 110₁-110₁₀ or the group of transceivers 210₁-210₈.

The transceiver(s) 310 can be functionally coupled to a positioning platform 320 via link(s) 316, which can permit the exchange of information (e.g., data, metadata, and/or signaling) between at least one of the transceiver(s) 310 and the positioning platform 320. The one or more links 316 can comprise wireless link(s), wireline link(s), or any combination thereof, and in certain implementations, can comprise or can be embodied in a vehicle bus, such as a controller area network (CAN) bus (CANbus).

The positioning platform 320 can embody or can constitute the positioning platform 120 or a positioning platform that may be deployed (e.g., installed, configured, and/or accepted) in the vehicle 204. As such, the positioning platform 320 can operate similarly to the positioning platform 120. More specifically, yet not exclusively, in the example operational environment 300, the positioning platform 320 can include a communication platform 322 that can receive information from and/or transmit information to at least one of the transceiver(s) 310. To at least such an end, the communication platform 326 can include an exchange component 326 that can permit the communication of information (data, metadata, and/or signaling) between the positioning platform 320 and at least one of the transceiver(s) 310. As an illustration, the exchange component 326 can be embodied in or can include input/output (I/O) interface(s), middleware, reference link(s), application programming interface(s), combinations thereof, or the like.

In one aspect, the information communicated from the positioning platform 320 to the transceiver(s) 310 can be include configuration directives that can configure at least one of the transceiver(s) 310 to operate in certain modality. As such, in the illustrated embodiment, the positioning platform 320 can include a mode configuration component 328 that can establish a specific modality of operation for one or more of the transceiver(s) 310. The specific modality of operation can include collision avoidance mode or active positioning mode, as described herein. In collision avoidance mode, for example, the mode configuration component 328 can direct or otherwise configure at least one of the light source(s) 312 to emit electromagnetic radiation (which can be either modulated or non-modulated). In certain embodiments, the emitted radiation is modulated in order for other vehicles to perform active positioning in accordance with aspects described herein. As described herein, such electromagnetic radiation can illuminate an environment of a vehicle (e.g., vehicle 104) having deployed thereon at least the transceiver(s) 310. In addition, one or more photodetectors of the photodetector(s) 314 can collect or otherwise receive at least a portion of the electromagnetic radiation that can scatter off an object (e.g., object 202) in response to the object being illuminated by a light source emitting at least a portion of the electromagnetic radiation (which can be either modulated or non-modulated). The one or more photodetectors can communicate imaging information representative of an image of the environment of the vehicle, including the object, to the positioning platform 320. Accordingly, the positioning platform 320 can receive—via the communication platform 322, for example—at least a portion of the imaging information and can process it. In one processing aspect, the communication platform 322 can convey or otherwise make available at least a portion of the received imaging information to a computing platform 336 that can determine or can be configured to determine relative positions of objects in an environment with respect to a vehicle having the photodetector(s) that provided the imaging information. More specifically, in one example, the computing platform 336 can determine one or more of such positions via photogrammetry in accordance with aspects of this disclosure. Therefore, in one aspect, the computing platform 336 can identify or otherwise determine an anchor point of an object based on the received imaging information, and can utilize or leverage the anchor point to determine the position of the object relative to the vehicle associated with the imaging information. In the illustrated embodiments, the computing platform 336 can implement (e.g., execute) photogrammetry techniques and/or leverage information structures that may be retained within the computing platform 336 and/or one or more memory devices 350 (represented as repository 350 in FIG. 3). In certain embodiments, one or more rendering units 340 (also referred to as rendering unit(s)) can convey information indicative or otherwise representative of at least a portion of the relative positions of such objects. In addition or in the alternative, at least one of the rendering unit(s) 340 can convey specific information, such as spatial arrangement of the objects and/or alerts or other indications, based at least on the determined relative positions of the objects in the environment.

In addition, in active positioning mode, the mode configuration component 328 can direct or otherwise configure at least one of the light source(s) 312 to emit modulated electromagnetic radiation in accordance with aspects described herein. More particularly, yet not exclusively, the modulated electromagnetic radiation can convey ID information indicative or otherwise representative of an identity or identification of a vehicle (e.g., a VIN or a custom code) that includes the transceiver(s) 310. In addition or in the alternative, as described herein, the modulated electromagnetic radiation also can convey information indicative of the respective location of each of the at least one of the light source(s) 312 that can emit at least a portion of the modulated radiation. Such respective location(s) can be represented and/or conveyed in coordinates relative to a reference frame in such a vehicle (e.g., the vehicle 104 or 204, or both). Accordingly, in one example implementation, the mode configuration component 328 can configure one or more of the light source(s) 312 to switch controllably between an emitting state and a non-emitting state. In addition, in response to such configuration, for example, the positioning platform 320 can include an optical switching component 332 that can modulate an ON/OFF signal that switches the one or more light sources between the emitting state (or ON state) and the non-emitting (or OFF state). In one aspect, the optical switching component 332 can compose or otherwise format the information conveyed in the electromagnetic radiation into packets, which therefore, can be communicated via the electromagnetic radiation. As described herein, the optical switching component 332 can utilize or otherwise the ON/OFF keying to generate such information. As such, as described herein, the positioning platform 320 can produce, via the optical switching component 328, packetized information, where in one aspect, the packets can include at least one packet including a respective first frame including payload data indicative of ID of the vehicle that include the transceiver(s) 312, and a respective second frame including second payload data indicative of the location of at least one light source that emits modulated electromagnetic radiation.

At least one of the photodetector(s) 314 can collect or otherwise receive modulated electromagnetic radiation. In active positioning mode, the positioning platform 320 can receive, via the communication platform 322, for example, information conveyed in at least a portion of the modulated electromagnetic radiation. To at least such an end, in one aspect, the exchange component 326 can receive the information. In addition, the exchange component 326 can convey or otherwise make available at least a portion of the information to the computing platform 336, which can process can process (e.g., demodulate and/or decode) at least the received portion of the information. In certain scenarios, as described herein, the modulated electromagnetic radiation that can be received by the at least one of the photodetector(s) 314 can be emitted or otherwise provided by a second vehicle similarly configured in active positioning mode in accordance with this disclosure. In one aspect, the modulated electromagnetic radiation received by the at least one of the photodetector(s) 314 can convey information indicative of an identification of the second vehicle (e.g., a VIN or a custom code) and/or information indicative of the respective location of one or more light sources (e.g., high-power LED(s)) that emit at least a portion of the modulated electromagnetic radiation from the second vehicle.

Further, in active positioning mode, the computing platform 336 can determine a location of a light source in a vehicle (e.g., the vehicle 206) that transmits modulated electromagnetic radiation in accordance with aspects of this disclosure. For example, the location of the light source can be conveyed in information modulated into the electromagnetic radiation emitted by the light source. As described herein, in one aspect, the location of such a light source can be conveyed in coordinates relative to a reference frame in such a vehicle (e.g., the vehicle 206). Based at least on the respective locations of one or more light sources in such a vehicle, the computing platform 336 can determine a relative position of a first vehicle that includes one or more of the photodetector(s) 314 (such as the vehicle 104), and can receive the modulated electromagnetic radiation with respect to a second vehicle that emits the modulated electromagnetic radiation (such as the vehicle 206). To at least such an end, in certain embodiments, the computing platform 336 can configure the location of each of the one or more light sources that emit the modulated radiation as a respective anchor point in the environment of the vehicle that includes the photodetector(s) 314, thereby yielding one or more anchor points. In addition, the computing platform 336 can access (e.g., receive or otherwise acquire) information indicative of the inclination of a photodetector of the photodetector(s) 314 that collects or otherwise receives at least a portion of the modulated electromagnetic radiation emitted by the one or more light sources in the second vehicle (e.g., the vehicle 206). For example, a sensor controller 330 can acquire inclination information from one or more sensors 318, which can be functionally coupled to one or more of the photodetector(s) 314. In addition, the computing platform 336 can determine the position of the first vehicle relative to the second vehicle via photogrammetry based at least on (A) the location of the one or more anchor points determined in accordance with aspects of this disclosure; and (B) the respective inclination of the photodetector that collects or otherwise receives at least a portion of the modulated electromagnetic radiation. In certain embodiments, as described herein, at least one of the rendering unit(s) 340 can convey information indicative or otherwise representative of at least a portion of the relative positions of one or more vehicles in the surroundings of the vehicle including the positioning platform 320. In addition or in the alternative, one or more of the rendering unit(s) 340 can convey specific information, such as spatial arrangement of the one or more vehicles and/or alerts or other indications, based at least on the determined relative positions.

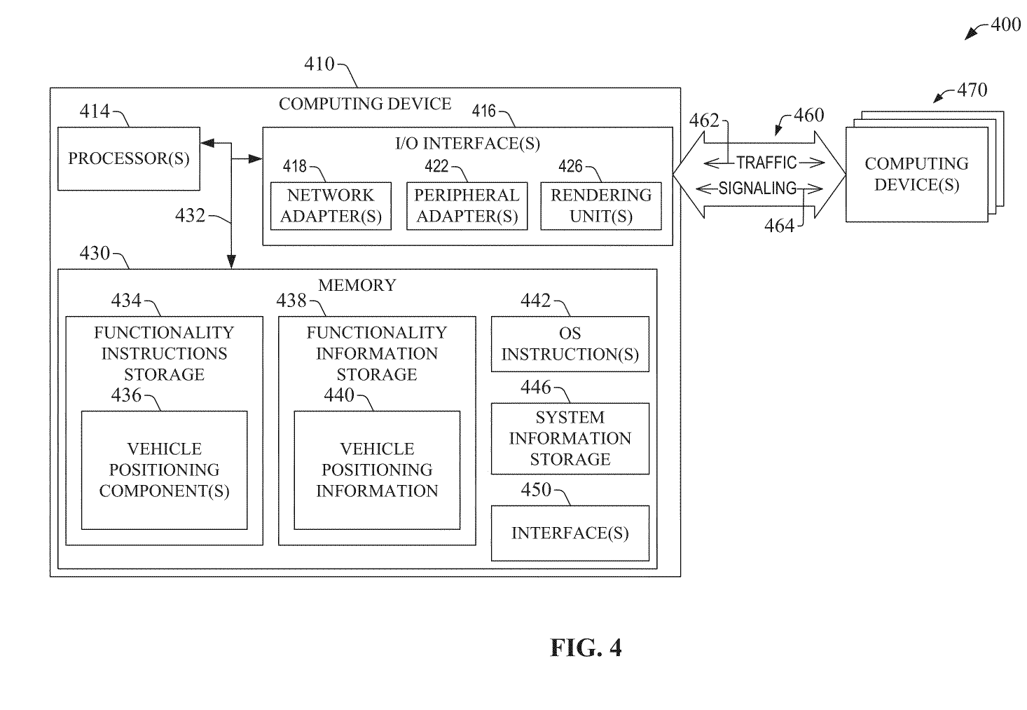

FIG. 4 illustrates a block diagram of an example operational environment 400 for vehicle positioning in accordance with one or more aspects of the disclosure. The example computational environment 400 is merely illustrative and is not intended to suggest or otherwise convey any limitation as to the scope of use or functionality of the computational environment's architecture. In addition, the illustrative computational environment 400 should not be interpreted as having any dependency or requirement relating to any one or combination of components illustrated in the example operational environments of the disclosure. The example computational environment 400 or portions thereof can embody or can comprise, for example, the positioning platform 320 (illustrated in FIG. 3) or a portion thereof, such as the computing platform 336 and/or the communication platform 322.

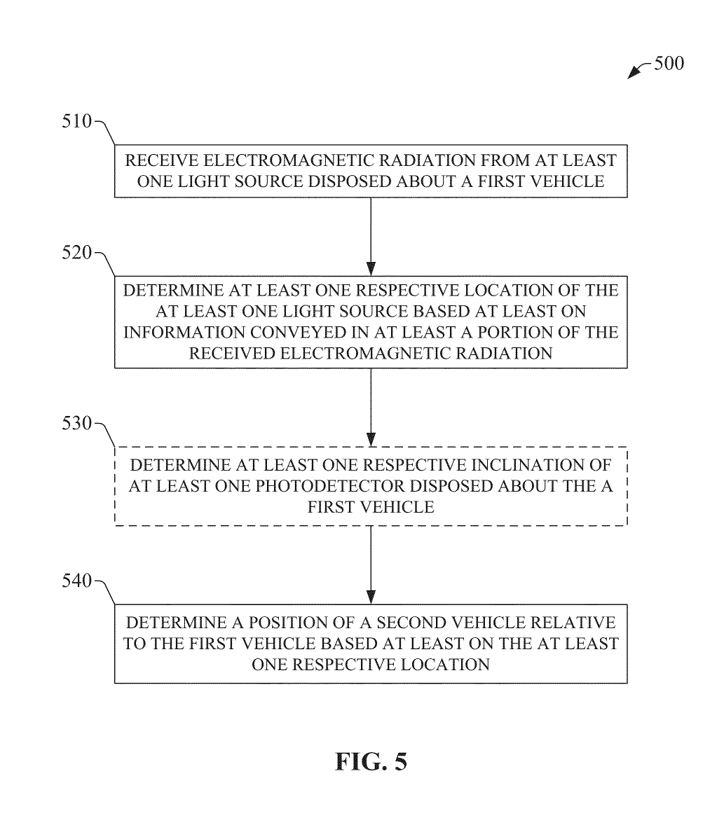

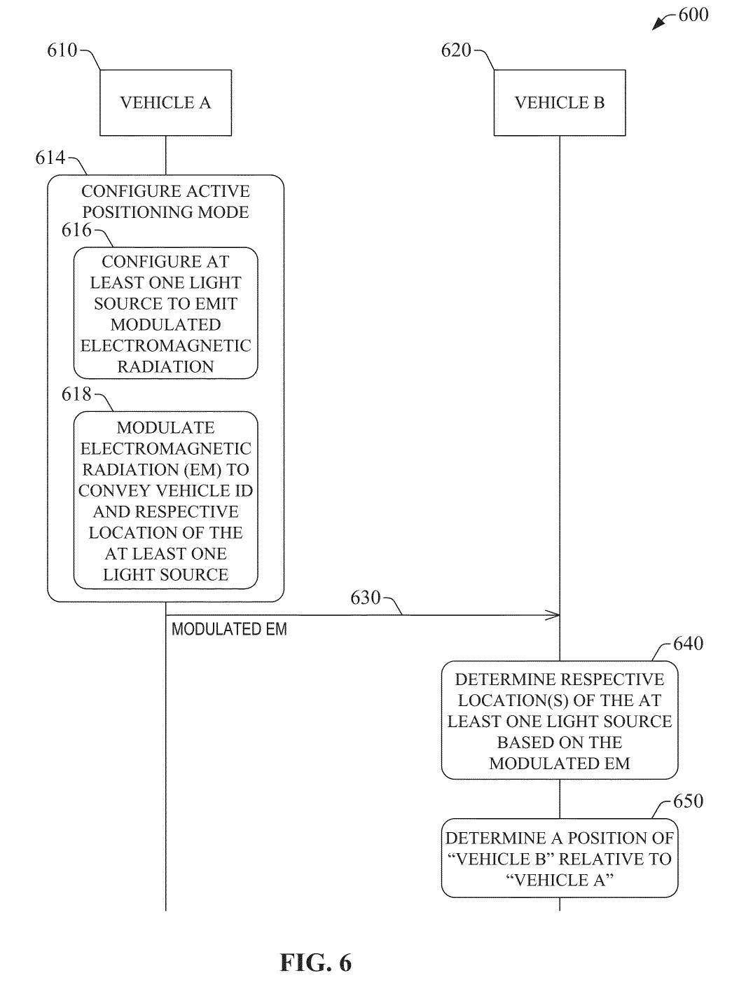

The example computational environment 400 represents an example implementation of various aspects or features of the disclosure in which the processing or execution of operations described in connection with the vehicle positioning disclosed herein can be performed in response to execution of one or more software components at the computing device 410 and/or at least one of the remote computing device(s) 470. It should be appreciated that the one or more software components can render the computing device 410, or any other computing device that contains such components, a particular machine for vehicle positioning in accordance with aspects of this disclosure, among other functional purposes. In one example, a software component can be embodied in or can comprise one or more computer-accessible instructions, e.g., computer-readable and/or computer-executable instructions. In one scenario, at least a portion of the computer-accessible instructions can embody and/or can be executed to perform at least a portion of one or more of the example methods described herein, such as the example methods presented in FIGS. 5-6. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can be assembled into one or more program modules, for example, that can be compiled, linked, and/or executed at the computing device 410 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 410 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with the vehicle positioning described herein can comprise personal computers; server computers; laptop computing devices; handheld computing devices, such as mobile tablets; wearable computing devices; and multiprocessor systems. Additional examples can include set-top boxes; programmable consumer electronics; networked personal computers (PCs); minicomputers; mainframe computers; blade computers; programmable logic controllers or other type of controllers (such as application specific controllers); distributed computing environments that comprise any of the above systems, computers and/or devices; and the like.

As illustrated, the computing device 410 can comprise one or more processors 414, one or more input/output (I/O) interfaces 416, a memory 430, and a bus architecture 432 (also termed bus 432) that functionally couples various functional elements of the computing device 410. In certain embodiments, the computing device 410 can include, optionally, a radio unit 412. The radio unit 412 can include one or more antennas and a communication processing unit that can permit wireless communication between the computing device 410 and another device, such as one of the computing device(s) 470. The bus 432 can include at least one of a system bus, a memory bus, an address bus, or a message bus, and can permit exchange of information (data, metadata, and/or signaling) between the processor(s) 414, the I/O interface(s) 416, and/or the memory 430, or respective functional elements therein. In certain scenarios, the bus 432 in conjunction with one or more internal programming interfaces 450 (also referred to as interface(s) 450) can permit such exchange of information. In scenarios in which the processor(s) 414 include multiple processors, the computing device 410 can utilize parallel computing.

The I/O interface(s) 416 can permit communication of information between the computing device and an external device, such as another computing device, e.g., a network element or an end-user device. Such communication can include direct communication or indirect communication, such as exchange of information between the computing device 410 and the external device via a network or elements thereof. As illustrated, the I/O interface(s) 416 can comprise one or more of network adapter(s) 418, peripheral adapter(s) 422, and rendering unit(s) 426. Such adapter(s) can permit or facilitate connectivity between the external device and one or more of the processor(s) 414 or the memory 430. For example, the peripheral adapter(s) 422 can include a group of ports, which can include at least one of parallel ports, serial ports, Ethernet ports, V.35 ports, or X.21 ports. In certain embodiments, the parallel ports can comprise General Purpose Interface Bus (GPIB), IEEE-1284, while the serial ports can include Recommended Standard (RS)-232, V.11, Universal Serial Bus (USB), FireWire or IEEE-1394.

In one aspect, at least one of the network adapter(s) 418 can functionally couple the computing device 410 to one or more computing devices 470 via one or more traffic and signaling pipes 460 that can permit or facilitate the exchange of traffic 462 and signaling 464 between the computing device 410 and the one or more computing devices 470. For example, one or more of such data and signaling pipes can embody or can constitute at least a portion of the components 144, components 146, component(s) 224, component(s) 226, and/or link(s) 228. Such network coupling provided at least in part by the at least one of the network adapter(s) 418 can be implemented in a wired environment, a wireless environment, or both. The information that is communicated by the at least one of the network adapter(s) 418 can result from the implementation of one or more operations of a method in accordance with aspects of this disclosure. Such output can be any form of visual representation, including, but not limited to, textual, graphical, animation, audio, tactile, and the like. In certain scenarios, each of the computing device(s) 470 can have substantially the same architecture as the computing device 410. In addition or in the alternative, the rendering unit(s) 426 can include functional elements (e.g., lights, such as light-emitting diodes; a display, such as a liquid crystal display (LCD), a plasma monitor, a light emitting diode (LED) monitor, or an electrochromic monitor; combinations thereof; or the like) that can permit control of the operation of the computing device 410, or can permit conveying or revealing the operational conditions of the computing device 410.

In one aspect, the bus 432 represents one or more of several possible types of bus structures, including a memory bus or a memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like. The bus 432, and all buses described herein can be implemented over a wired or wireless network connection and each of the subsystems, including the processor(s) 414, the memory 430 and memory elements therein, and the I/O interface(s) 416 can be contained within one or more remote computing devices 470 at physically separate locations, connected through buses of this form, in effect implementing a fully distributed system.

The computing device 410 can comprise a variety of computer-readable media. Computer-readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 410, and can comprise, for example, both volatile and non-volatile media, and removable and/or non-removable media. In one aspect, the memory 430 can comprise computer-readable media in the form of volatile memory, such as random access memory (RAM), and/or non-volatile memory, such as read-only memory (ROM).

The memory 430 can comprise functionality instructions storage 434 and functionality information storage 438. The functionality instructions storage 434 can comprise computer-accessible instructions that, in response to execution (by at least one of the processor(s) 414), can implement one or more of the functionalities of the disclosure. The computer-accessible instructions can embody or can comprise one or more software components illustrated as vehicle positioning component(s) 436. In one scenario, execution of at least one component of the vehicle positioning component(s) 436 can implement one or more of the methods described herein, such as example method 400. For instance, such execution can cause a processor (e.g., one of the processor(s) 414) that executes the at least one component to carry out a disclosed example method. It should be appreciated that, in one aspect, a processor of the processor(s) 414 that executes at least one of the vehicle positioning component(s) 436 can retrieve information from or retain information in one or more memory elements 440 in the functionality information storage 438 in order to operate in accordance with the functionality programmed or otherwise configured by the vehicle positioning component(s) 436. The one or more memory elements 440 may be referred to as vehicle positioning information 440. Such information can include at least one of code instructions, information structures, or the like. For instance, at least a portion of such information structures can be indicative or otherwise representative of relative positions of objects or vehicles in an environment of a vehicle that leverages or otherwise utilizes the computing device 410 for vehicle positioning in accordance with aspects of this disclosure. In addition, at least the vehicle positioning information 440 can include one or more representations (e.g., computer-accessible instructions) of photogrammetry techniques, and/or information structures that can permit implementation (e.g., execution and/or utilization) of such techniques in accordance with one or more aspects of this disclosure. In certain embodiments, the functionality information storage 438 can embody or can constitute the repository 350. In other embodiments, the repository 350 can be distributed between the functionality information storage 438 and similar storage devices present in or functionally coupled to one or more of the computing device(s) 470.

In certain embodiments, one or more of the vehicle positioning component(s) 436 can embody or can constitute at least one of the exchange component 326, the mode configuration component 328, the sensor controller 330, and/or the optical switching component 332, and can provide the functionality of such functional elements in accordance with aspects of this disclosure. In other embodiments, one or more of the vehicle positioning component(s) 436 in combination with at least one of the processor(s) 414 and/or at least one of the I/O interface(s) 416 can embody or can constitute at least one of the exchange component 326, the mode configuration component 328, the sensor controller 330, and/or the optical switching component 332, and can provide the functionality of such units in accordance with aspects of this disclosure. In addition, at least one second processor of the processor(s) 414 and/or one or more of the vehicle component(s) 436 can embody or can constitute the computing platform 336. In other embodiments, at least one of the remote computing devices 470 can have an architecture similar to that of the computing device 410, and the communication platform 322 or a component thereof, the computing platform 336, and/or the repository 350 can be implemented in a distributed fashion via the at least one of the computing devices 470 and the computing device 410. In one example, in such distributed environments, at least a portion of the implementation (e.g., execution and/or computation) of the collision avoidance mode and/or the active vehicle positioning described herein may be performed partially or entirely in at least one of the remote computing device 470, and the information pertinent to such implementation, such as collection or measurement of electromagnetic radiation (which can be modulated or non-modulated) and/or communication of electromagnetic radiation in accordance with aspects of this disclosure can be carried out in a vehicle that contains the computing device 410.

At least one of the one or more interfaces 450 (e.g., application programming interface(s)) can permit or facilitate communication of information between two or more components within the functionality instructions storage 434. The information that is communicated by the at least one interface can result from the implementation of one or more operations in a method of the disclosure. In certain embodiments, one or more of the functionality instructions storage 434 and the functionality information storage 438 can be embodied in or can comprise removable/non-removable, and/or volatile/non-volatile computer storage media.

At least a portion of at least one of the vehicle positioning component(s) 436 or vehicle positioning information 440 can program or otherwise configure one or more of the processors 414 to operate at least in accordance with the functionality described herein. One or more of the processor(s) 414 can execute at least one of the vehicle positioning component(s) 436 and leverage at least a portion of the information in the functionality information storage 438 in order to provide vehicle positioning in accordance with one or more aspects described herein.

It should be appreciated that, in certain scenarios, the functionality instruction(s) storage 434 can embody or can comprise a computer-readable non-transitory storage medium having computer-accessible instructions that, in response to execution, cause at least one processor (e.g., one or more of the processor(s) 414) to perform a group of operations comprising the operations or blocks described in connection with the disclosed methods.

In addition, the memory 430 can comprise computer-accessible instructions and information (e.g., data, metadata, and/or programming code instructions) that permit or facilitate the operation and/or administration (e.g., upgrades, software installation, any other configuration, or the like) of the computing device 410. Accordingly, as illustrated, the memory 430 can comprise a memory element 442 (labeled operating system (OS) instruction(s) 442) that contains one or more program modules that embody or include one or more operating systems, such as Windows operating system, Unix, Linux, Symbian, Android, Chromium, and substantially any OS suitable for mobile computing devices or tethered computing devices. In one aspect, the operational and/or architectural complexity of the computing device 410 can dictate a suitable OS. The memory 430 also comprises a system information storage 446 having data, metadata, and/or programming code that permits or facilitates the operation and/or administration of the computing device 410. Elements of the OS instruction(s) 442 and the system information storage 446 can be accessible or can be operated on by at least one of the processor(s) 414.

It should be recognized that while the functionality instructions storage 434 and other executable program components, such as the OS instruction(s) 442, are illustrated herein as discrete blocks, such software components can reside at various times in different memory components of the computing device 410, and can be executed by at least one of the processor(s) 414. In certain scenarios, an implementation of the vehicle positioning component(s) 436 can be retained on or transmitted across some form of computer-readable media.

The computing device 410 and/or one of the computing device(s) 470 can include a power supply (not shown), which can power up components or functional elements within such devices. The power supply can be a rechargeable power supply, e.g., a rechargeable battery, and it can include one or more transformers to achieve a power level suitable for the operation of the computing device 410 and/or one of the computing device(s) 470, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 418) to connect operationally to the conventional power grid. In another aspect, the power supply can include an energy conversion component, such as a solar panel, to provide additional or alternative power resources or autonomy for the computing device 410 and/or one of the computing device(s) 470.

As described herein, the computing device 410 can operate in a networked environment by utilizing connections to one or more remote computing devices 470. As an illustration, a remote computing device can be a personal computer, a portable computer, a server, a router, a network computer, a peer device or other common network node, and so on. As described herein, connections (physical and/or logical) between the computing device 410 and a computing device of the one or more remote computing devices 470 can be made via one or more traffic and signaling pipes 460, which can comprise wired link(s) and/or wireless link(s) and several network elements (such as routers or switches, concentrators, servers, and the like) that form a local area network (LAN), a wide area network (WAN), and/or other networks (wireless or wired) having different footprints. Such networking environments are conventional and commonplace in dwellings, offices, enterprise-wide computer networks, intranets, local area networks, and wide area networks.

In certain embodiments, as described herein, one or more of the disclosed functionality (such as methods) can be practiced in distributed computing environments, such as grid-based environments or cloud configurations, where tasks can be performed by remote processing devices (computing device(s) 470) that are functionally coupled (e.g., communicatively linked or otherwise coupled) through a network having traffic and signaling pipes and related network elements. For example, in a distributed computing environment, one or more software components (such as program modules) can be located in both a local computing device 410 and at least one of the remote computing device(s) 470.

In view of the aspects described herein, example techniques that can be implemented in accordance with this disclosure can be better appreciated with reference to the diagrams in FIGS. 5-6. For purposes of simplicity of explanation, the example methods disclosed herein are presented and described as a series of blocks (with each block representing an action or an operation in a method, for example). However, it is to be understood and appreciated that the disclosed methods are not limited by the order of blocks and associated actions or operations, as some blocks may occur in different orders and/or concurrently with other blocks from that shown and described herein. For example, the various methods or processes of the disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

It should be appreciated that the methods of the disclosure can be retained on an article of manufacture, or computer-readable storage medium, to permit or facilitate transporting and transferring such methods to a computing device (e.g., a desktop computer; a mobile computer, such as a tablet computer or a smartphone; an Ultrabook™ computer; a gaming console, a mobile telephone; a blade computer; a programmable logic controller, and the like) for execution, and thus implementation, by a processor of the computing device or for storage in a memory thereof or functionally coupled thereto. In one aspect, one or more processors, such as processor(s) that implement (e.g., execute) one or more of the disclosed methods, can be employed to execute code instructions retained in a memory, or any computer- or machine-readable medium, to implement the one or more methods. The code instructions can provide a computer-executable or machine-executable framework to implement the methods described herein.

FIG. 5 presents a flowchart of an example method 500 for vehicle positioning according to at least certain aspects of this disclosure. One or more computing devices having at least one processor or being functionally coupled to at least one processor can implement (e.g., compile, execute, compile and execute, etc.) one or more blocks of the subject example method 500. In other scenarios, one or more blocks of the example method 1000 can be implemented in a distributed fashion by two or more computing devices contained in a system. Each of the two or more computing devices can have at least one processor or can be functionally coupled to at least one processor, where such processor(s) can implement at least one of the one or more blocks. At block 510, electromagnetic radiation can be received from at least one light source disposed (e.g., embedded or otherwise coupled (mechanically or otherwise)) about a first vehicle (e.g., vehicle 210). In one example, as described herein, the at least one light source (e.g., at least one of light source(s) 312) can include a group of two or more beacons that can emit at least a portion of the electromagnetic radiation. In addition, it should be appreciated that, in one aspect, the first vehicle can be configured or otherwise programmed to emit electromagnetic radiation via one or more light sources disposed about the first vehicle.

At block 520, at least one respective location of the at least one light source can be determined based at least on information conveyed in at least a portion of the received electromagnetic radiation. In addition, in certain embodiments, an identity of the first vehicle can be determined or otherwise accessed based on second information conveyed in at least a second portion of the received electromagnetic radiation. In certain implementations, the received electromagnetic radiation can be modulated to convey information indicative or otherwise representative of an identity of the first vehicle and/or a respective location of the at least light source.

At block 530, at least one respective inclination of at least one photodetector disposed about the first vehicle can be optionally determined. It should be appreciated that, in one example scenario, the at least one photodetector can be collect or otherwise receive the electromagnetic radiation. In one example, such inclination(s) can be determined (e.g., measured or otherwise detected) by at least one inclination sensor (one of the sensor(s), for example), and information indicative of the inclination(s) can be supplied (e.g., communicated) to the computing platform (e.g., computing platform 336) that implements the subject example method 500. In certain example scenarios, instead of being determined, the at least one inclination can be accessed from one or more memory devices (e.g., the repository 350) containing positioning information including inclination information (e.g., data or metadata) indicative or otherwise representative of respective inclination(s) of a group of photodetectors disposed about or otherwise coupled to (e.g., fitted, mechanically or otherwise) the first vehicle.

At block 540, a position of a second vehicle (e.g., vehicle 104) relative to the first vehicle can be determined based at least on the at least one respective location of the at least one light source. In one example, determining such a position can include configuring the at least one light source as at least one respective anchor point, and determining (e.g., computing) the position via photogrammetry based at least on (a) the at least one respective anchor point, (b) the at least one respective location of the at least one light source, (c) and at least one respective inclination of the at least one photodetector. As described herein, the at least respective inclination can be determined at block 530 or can be accessed from one or more memory devices.

FIG. 6 presents a call-flow of an example method 600 for vehicle positioning according to at least certain aspects of this disclosure. The example method 600 presents, certain configuration aspects of a mode of operation of a group of light sources embedded or otherwise disposed about a vehicle in order to permit vehicle positioning in accordance with aspects of this disclosure. As illustrated, at block 614, a vehicle A 610 can configure an active positioning mode. Block 614 can include block 616, at which at least one light source (e.g., at least one of light sources 312) can be configured to emit modulated electromagnetic radiation. In one example, configuring a light source of the at least one light sources can include configuring the light source to switch controllably between an ON state and an OFF state.

Block 614 also can include block 618, at which at least a portion of the electromagnetic radiation can be modulated to convey an identification of the vehicle A 610, and respective location(s) of the at least one light source within the vehicle A 610. In one example, modulating the electromagnetic radiation can include modulating an ON/OFF signal that switches the at least one light source between the ON and OFF states. In addition, the modulated ON/OFF switching can permit composing or otherwise formatting the information conveyed in the electromagnetic radiation into packets, which therefore, can be communicated via the electromagnetic radiation. As such, the information can be packetized and, in one aspect, the packets can include at least one packet including a respective first frame including payload data indicative of the identification of the vehicle A 610, and a respective second frame including second payload data indicative of the location of the at least one light source that emits the electromagnetic radiation. As described herein, in one aspect, the respective location(s) can be established and/or conveyed in coordinates within the vehicle A 610 as a frame of reference.

The at least one configured light source associated with the vehicle A 610 can transmit the modulated electromagnetic radiation (EM), which is pictorially represented a modulated EM 630. A vehicle B 620 having photodetectors configured to collect or otherwise measure the transmitted modulated EM 630 can receive at least a portion of such electromagnetic radiation. In accordance with aspects of the disclosure, the vehicle B 620 can be in proximity of the vehicle A 610 in order to receive electromagnetic radiation emitted from the vehicle A 610.

At block 640, the vehicle B 620 or a component thereof (e.g., the positioning platform 120) can determine the respective location(s) of the at least one light source based on at least the received portion of the modulated EM 630. In addition, at block 650, the vehicle B 620 can determine a position of the vehicle B 620 relative to the vehicle A 650. As described herein, such a determination can be made via photogrammetry, relying on the respective location(s) of the at least one light source as anchor photogrammetry feature point(s). More specifically, yet not exclusively, blocks 640 and 650 can be implemented according to at least a portion of the example method 500.

Further or alternative example embodiments of the disclosure emerge from the description herein and annexed drawings. For example, the disclosure can provide a system for vehicle positioning, where the system can include a plurality of first light sources disposed about a first vehicle; a plurality of photodetectors disposed about the first vehicle and configured to receive electromagnetic radiation from at least one second light source disposed about a second vehicle; and a computing device comprising at least one processor functionally coupled to the at least one memory device, the computing device is functionally coupled to at least one first light source of the plurality of first light sources and at least one photodetector of the plurality of photo detectors. In such a system the at least one memory device can include instructions (e.g., computer-accessible instructions) stored thereon, and the at least one processor can be configured, by the instructions, to determine at least one respective location of the at least one second light source based at least on information conveyed in at least a portion of the electromagnetic radiation; and to determine a position of the second vehicle relative to the first vehicle based at least on the at least one respective location of the at least one second light source.

In certain aspects, the at least one processor in such a system can be further configured, by the instructions, to configure each of the at least one second light source as a respective anchor point, thereby yielding at least one anchor point, and to determine the position of the second vehicle relative to the first vehicle via photogrammetry based at least on the at least one anchor point, and at least one inclination of at least one of the plurality of photodetectors that receives at least a portion of the electromagnetic radiation.

In another aspect, at least one first light source of the plurality of first light sources contained in such a system can include a light emitting diode configured to emit electromagnetic radiation substantially within the infra-red portion of the spectrum of electromagnetic radiation.

In yet another aspect, at least one photodetector of the plurality of photodetectors contained in such a system can include a camera having a predetermined frame detection rate ranging from about 200 frames per second to about 20000 frames per second.

In still another aspect, such a system also can include a plurality of sensors (such as inclination sensors) respectively associated with the plurality of photodetectors. Each of the plurality of sensors can be configured at least to determine an inclination of a respective photodetector of the plurality of photodetectors.

In a further aspect, the at least one processor contained in such a system can be further configured, by the instructions, to determine an identity of the second vehicle based on information conveyed via at least a portion of electromagnetic radiation that may be received at the system via, for example, the plurality of photodetectors. In addition or in the alternative, the at least one processor can be further configured, by the instructions, to configure the at least one first light source of the plurality of first light sources to emit electromagnetic radiation that can convey information indicative of an identity of the vehicle (e.g., a vehicle ID) and respective location(s) of the at least one light source within the vehicle. As described herein, the electromagnetic radiation can be modulated based at least on ON/OFF keying. In addition, and at least a portion of the information can be packetized. More particularly, in one example, each packet in at least the portion of the information comprises a first frame including payload data indicative of the identity of the vehicle, and a second frame including second payload data indicative of the location of the at least one light source within the vehicle.

In another example, the disclosure can provide a method for vehicle positioning, where the method can comprise receiving, via at least one photodetector, electromagnetic radiation from at least one light source disposed about a first vehicle; determining, via a computing device, at least one respective location of the at least one light source based at least on information conveyed in at least a portion of the received electromagnetic radiation; and determining, via the computing device, a position of a second vehicle relative to the first vehicle based at least on the at least one respective location. In addition, in certain embodiments, the method can include determining, via at least one sensor, at least one respective inclination of the at least one photodetector prior to determining, via the computing system, the position of the second vehicle relative to the first vehicle, wherein the at least one photodetector is disposed about the second vehicle.

In one aspect, as described herein, relative position of a vehicle with respect to another vehicle can be determined based on photogrammetry. Accordingly, in one aspect of such a method, determining, via the computing system, the position of the second vehicle relative to the first vehicle can include configuring the at least one light source as at least one respective anchor point, and determining the position of the second vehicle relative to the first vehicle via photogrammetry based at least on the at least one respective anchor point, the at least one respective location of the at least one light source, and at least one respective inclination of the at least one photodetector.

In another aspect, the example method also can include determining, via the computing device, an identity of the first vehicle based on second information conveyed in at least a second portion of the received electromagnetic radiation. In yet another aspect, the example method also can include configuring, via the computing device, at least one second light source to emit electromagnetic radiation that conveys information indicative of an identity of the second vehicle and a respective location within the second vehicle of the at least one second light source. More specifically, yet not exclusively, configuring the at least one second light source to emit the electromagnetic radiation comprises modulating an ON/OFF signal that switches the at least one second light source. In addition or in the alternative, the example method can include formatting information into at least one packet configured to be communicated via the electromagnetic radiation, the at least one packet comprises a respective first frame including payload data indicative of the identity of the second vehicle, and a respective second frame including second payload data indicative of the location of the at least one second light source.

The disclosure also can provide a an example computing device for vehicle positioning, wherein the computing device can include at least one memory device having instructions encoded thereon; and at least one processor functionally coupled to the at least one memory device and configured, in response to execution of the instructions, to determine at least one respective location of at least one light source associated with a first vehicle based at least on information received via at least one photodetector; and to determine a position of a second vehicle relative to the first vehicle based at least on the at least one respective location.

In one aspect, the at least one processor contained in the example computing device can be further configured, in response to execution of the instructions, to determine at least one respective inclination of the at least one photodetector prior to a determination of the position of the second vehicle relative to the first vehicle, wherein the at least one photodetector is disposed about the second vehicle. In addition or in the alternative, in another aspect, the at least one processor contained in the example computing device can be further configured, in response to execution of the instructions, to configure the at least one light source as at least one respective anchor point, and to determine the position of the second vehicle relative to the first vehicle via photogrammetry based at least on the at least one respective anchor point, the at least one respective location of the at least one light source, and at least one respective inclination of the at least one photodetector.

In yet another aspect, the at least one processor contained in the example computing device can be further configured, in response to execution of the instructions, to configure at least one second light source to emit electromagnetic radiation that conveys information indicative of an identity of the second vehicle and a respective location within the second vehicle of the at least one second light source.

In still another aspect, the at least one processor contained in the example device is further configured, in response to execution of the instructions, to modulate an ON/OFF signal that switches the at least one second light source. In addition or in the alternative, the at least one processor contained in the example computing device can be further configured, in response to execution of the instructions, to format information into at least one packet configured to be communicated via the electromagnetic radiation, the at least one packet comprises a respective first frame including payload data indicative of the identity of the second vehicle, and a respective second frame including second payload data indicative of the location of the at least one second light source.

In another example, the disclosure can provide at least one computer-readable non-transitory storage medium encoded with computer-accessible instructions that, in response to execution, cause at least one processor to perform vehicle positioning operations comprising receiving, from at least one photodetector, lighting information indicative of the presence of at least one light source associated with a first vehicle; determining at least one respective location of the at least one light source based at least on the lighting information; and determining a position of a second vehicle relative to the first vehicle based at least on the at least one respective location.

In addition or in the alternative, the vehicle positioning operations associated with the at least one computer-readable non-transitory storage can include configuring the at least one light source as at least one respective anchor feature, and determining the position of the second vehicle relative to the first vehicle via photogrammetry based at least on the at least one respective anchor point, the at least one respective location of the at least one light source, and at least one respective inclination of the at least one photodetector.

In certain implementations, the vehicle positioning operations associated with the at least one computer-readable non-transitory storage medium can further include configuring at least one second light source to emit electromagnetic radiation that conveys information indicative of an identity of the second vehicle and a respective location within the second vehicle of the at least one second light source. In other implementations, the vehicle positioning operations can further include modulating an ON/OFF signal that switches the at least one second light source. In yet other implementations, the vehicle positioning operations associated with the at least one computer-readable non-transitory storage medium can include formatting information into at least one packet configured to be communicated via the electromagnetic radiation, the at least one packet comprises a respective first frame including payload data indicative of the identity of the second vehicle, and a respective second frame including second payload data indicative of the location of the at least one second light source.

In one aspect, the vehicle positioning operations associated with the at least one computer-readable non-transitory storage medium can further include determining at least one respective inclination of the at least one photodetector prior to determining the position of the second vehicle relative to the first vehicle, wherein the at least one photodetector is disposed about the second vehicle.

The disclosure can provide another example system for vehicle positioning, where the example system can include means for illuminating an environment of a first vehicle, where the means for illuminating being disposed on the first vehicle. The example system also can include means for detecting electromagnetic radiation from at least one light source disposed about a second vehicle, where the means for detecting electromagnetic radiation being disposed on the first vehicle. The example system also can include means for computing, the computing device is functionally coupled to at least one first light source of the plurality of first light sources and at least one photodetector of the plurality of photodetectors; means for determining at least one respective location of the at least one second light source based at least on information conveyed in at least a portion of electromagnetic radiation received at the second vehicle; and means for determining a position of the second vehicle relative to the first vehicle based at least on the at least one respective location of the at least one second light source.

In certain implementations, the example system also can include means for configuring each of the at least one second light source as a respective anchor point, thereby yielding at least one anchor point, and means for determining the position of the second vehicle relative to the first vehicle via photogrammetry based at least on the at least one anchor point, and at least one inclination of the means for detecting electromagnetic radiation that receives at least a portion of the electromagnetic radiation received at the first vehicle.

In other implementations, the example system also can include means for sensing inclination associated with the means for detecting electromagnetic radiation, where the means for sensing being configured for determining an inclination of a respective means for detecting electromagnetic radiation.

In yet other implementations, the example system also can include means for determining an identity of the second vehicle based on information conveyed via electromagnetic radiation received at the first vehicle.

In still other implementations, the example system can include means for configuring the means for illuminating to emit electromagnetic radiation that conveys information indicative of an identity of the first vehicle and location of the at least one light source within the first vehicle. In one example, the emitted electromagnetic radiation is modulated based on ON/OFF keying, and at least a portion of the information is packetized. In addition or in the alternative, each packet in at least the portion of the information can include a first frame including payload data indicative of the identity of the vehicle, and a second frame including second payload data indicative of the location of the at least one light source within the vehicle.

In another example, the disclosure provides at least one processor-accessible non-transitory storage device having programmed instructions for vehicle positioning that, in response to execution, cause at least one processor to perform one or more of the methods described or otherwise disclosed herein.

In yet another example, the disclosure provides at least one processor-accessible (e.g., computer-readable) non-transitory storage device having programmed instructions for vehicle positioning that, in response to execution, cause at least one processor to perform one or more methods and/or realize one or more apparatuses described or otherwise disclosed herein.

The disclosure provides other embodiments for vehicle positioning in accordance with the disclosure. For example the disclosure provides an apparatus comprising means for performing one or more of the methods described or otherwise conveyed herein. In another example, the disclosure provides a computing device for vehicle positioning, comprising a communication platform configured to lighting information indicative of the presence of at least one light source associated with a first vehicle; and a computing platform functionally coupled to the communication platform, where the computing platform can be arranged to perform any of the methods described or otherwise disclosed herein.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “platform,” “system,” “architecture,” “interface,” “unit,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that provides, at least in part, the functionality of the electronic components. An interface can include input/output (I/O) components as well as associated processor, application, and/or other programming components. The terms “component,” “environment,” “platform,” “system,” “architecture,” “interface,” “unit,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components;” functional entities embodied in or comprising a memory device or storage device; or components forming the memory device or storage device. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, and techniques that can provide vehicle positioning, which can be implemented in accordance with multiple modalities that permit or facilitate assisted driving. It is, of course, not possible to describe every conceivable combination of elements and/or methods for purposes of describing the various features of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A system for vehicle positioning, comprising:
a plurality of first light sources disposed about a first vehicle;
a plurality of photodetectors disposed about the first vehicle and configured to receive electromagnetic radiation from at least one second light source disposed about a second vehicle;
a computing device comprising at least one processor functionally coupled to the at least one memory device, the computing device is functionally coupled to at least one first light source of the plurality of first light sources and at least one photodetector of the plurality of photodetectors;
the at least one memory device having instructions stored thereon, and the at least one processor configured, by the instructions,
to determine at least one respective location of the at least one second light source based at least on information conveyed in at least a portion of the electromagnetic radiation; and
to determine a position of the second vehicle relative to the first vehicle based at least on the at least one respective location of the at least one second light source.

2. The system of claim 1, wherein the at least one processor is further configured, by the instructions,
to configure each of the at least one second light source as a respective anchor point, thereby yielding at least one anchor point, and
to determine the position of the second vehicle relative to the first vehicle via photogrammetry based at least on the at least one anchor point, and at least one inclination of at least one of the plurality of photodetectors that receives at least a portion of the electromagnetic radiation.

3. The system of claim 1, wherein at least one first light source of the plurality of first light sources comprises a light emitting diode configured to emit electromagnetic radiation substantially within the infra-red portion of the spectrum of electromagnetic radiation.

4. The system of claim 1, wherein at least one photodetector of the plurality of photodetectors comprises a camera having a predetermined frame detection rate ranging from about 200 frames per second to about 20000 frames per second.

5. The system of claim 1, further comprising a plurality of sensors respectively associated with the plurality of photodetectors, each of the plurality of sensors configured at least to determine an inclination of a respective photodetector of the plurality of photodetectors.

6. The system of claim 1, wherein the at least one processor is further configured, by the instructions, to determine an identity of the second vehicle based on information conveyed via the received electromagnetic radiation.

7. The system of claim 1, wherein the at least one processor is further configured, by the instructions, to configure the at least one first light source of the plurality of first light sources to emit electromagnetic radiation that conveys information indicative of an identity of the vehicle and location of the at least one light source within the vehicle.

8. The system of claim 8, wherein the electromagnetic radiation is modulated based on ON/OFF keying, and at least a portion of the information is packetized.

9. The system of claim 9, wherein each packet in at least the portion of the information comprises a first frame including payload data indicative of the identity of the vehicle, and a second frame including second payload data indicative of the location of the at least one light source within the vehicle.

10. A method for vehicle positioning, comprising:
receiving, via at least one photodetector, electromagnetic radiation from at least one light source disposed about a first vehicle;
determining, via a computing device, at least one respective location of the at least one light source based at least on information conveyed in at least a portion of the received electromagnetic radiation; and
determining, via the computing device, a position of a second vehicle relative to the first vehicle based at least on the at least one respective location.

11. The method of claim 11, further comprising determining, via at least one sensor, at least one respective inclination of the at least one photodetector prior to determining, via the computing system, the position of the second vehicle relative to the first vehicle, wherein the at least one photodetector is disposed about the second vehicle.

12. The method of claim 11, wherein determining, via the computing system, the position of the second vehicle relative to the first vehicle comprises configuring the at least one light source as at least one respective anchor point, and
determining the position of the second vehicle relative to the first vehicle via photogrammetry based at least on the at least one respective anchor point, the at least one respective location of the at least one light source, and at least one respective inclination of the at least one photodetector.

13. The method of claim 11, further comprising determining, via the computing device, an identity of the first vehicle based on second information conveyed in at least a second portion of the received electromagnetic radiation.

14. The method of claim 1, further comprising configuring, via the computing device, at least one second light source to emit electromagnetic radiation that conveys information indicative of an identity of the second vehicle and a respective location within the second vehicle of the at least one second light source.

15. The method of claim 15, wherein configuring the at least one second light source to emit the electromagnetic radiation comprises modulating an ON/OFF signal that switches the at least one second light source.

16. The method of claim 15, further comprising formatting information into at least one packet configured to be communicated via the electromagnetic radiation, the at least one packet comprises a respective first frame including payload data indicative of the identity of the second vehicle, and a respective second frame including second payload data indicative of the location of the at least one second light source.

17. A computing device for vehicle positioning, comprising:
at least one memory device having instructions encoded thereon; and
at least one processor functionally coupled to the at least one memory device and configured, in response to execution of the instructions,
to determine at least one respective location of at least one light source associated with a first vehicle based at least on information received via at least one photodetector; and
to determine a position of a second vehicle relative to the first vehicle based at least on the at least one respective location.

18. The computing device of claim 17, wherein the at least one processor is further configured, in response to execution of the instructions, to determine at least one respective inclination of the at least one photodetector prior to a determination of the position of the second vehicle relative to the first vehicle, wherein the at least one photodetector is disposed about the second vehicle.

19. The computing device of claim 17, wherein the at least one processor is further configured, in response to execution of the instructions, to configure the at least one light source as at least one respective anchor point, and
to determine the position of the second vehicle relative to the first vehicle via photogrammetry based at least on the at least one respective anchor point, the at least one respective location of the at least one light source, and at least one respective inclination of the at least one photodetector.

20. The computing device of claim 17, wherein the at least one processor is further configured, in response to execution of the instructions, to configure at least one second light source to emit electromagnetic radiation that conveys information indicative of an identity of the second vehicle and a respective location within the second vehicle of the at least one second light source.

21. The computing device of claim 20, wherein the at least one processor is further configured, in response to execution of the instructions, to modulate an ON/OFF signal that switches the at least one second light source.

22. The computing device of claim 20, wherein the at least one processor is further configured, in response to execution of the instructions, to format information into at least one packet configured to be communicated via the electromagnetic radiation, the at least one packet comprises a respective first frame including payload data indicative of the identity of the second vehicle, and a respective second frame including second payload data indicative of the location of the at least one second light source.

23. At least one computer-readable non-transitory storage medium encoded with computer-accessible instructions that, in response to execution, cause at least one processor to perform vehicle positioning operations comprising:
receiving, from at least one photodetector, lighting information indicative of the presence of at least one light source associated with a first vehicle;
determining at least one respective location of the at least one light source based at least on the lighting information; and
determining a position of a second vehicle relative to the first vehicle based at least on the at least one respective location.

24. The at least one computer-readable non-transitory storage medium of claim 23, wherein the vehicle positioning operations further comprise configuring the at least one light source as at least one respective anchor feature, and
determining the position of the second vehicle relative to the first vehicle via photogrammetry based at least on the at least one respective anchor point, the at least one respective location of the at least one light source, and at least one respective inclination of the at least one photodetector.

25. The at least one computer-readable non-transitory storage medium of claim 23, wherein the vehicle positioning operations further comprise configuring at least one second light source to emit electromagnetic radiation that conveys information indicative of an identity of the second vehicle and a respective location within the second vehicle of the at least one second light source.
